(19) United States
(12) Patent Application Publication
(10) Pub. No.: US 2025/0371136 A1
(43) Pub. Date: Dec. 4, 2025

(54) SECURITY RISK MITIGATION FOR CLOUD RESOURCES

(71) Applicant: Microsoft Technology Licensing, LLC, Redmond, WA (US)

(72) Inventors: Josef WEIZMAN, Haifa (IL); Ram Haim PLISKIN, Rishon Lezion (IL)

(21) Appl. No.: 18/678,436

(22) Filed: May 30, 2024

(51) Int. Cl. G06F 21/55; G06F 21/60

(52) U.S. Cl. CPC G06F 21/552; G06F 21/604

(57) ABSTRACT

Systems and methods are disclosed herein for mitigating a security risk. In an example system, a resource ownership mapping is obtained that contains ownership information for resource names. For instance, the resource ownership mapping maps a resource name to a history of ownerships of the resource name and an action associated with the resource name. In an example, the history of ownerships includes a first owner. From the resource ownership mapping, a first ownership change of the resource name relating to the first owner is determined. A reference to the resource name in a first computing environment associated with the first owner is identified. A preventative action is performed to reduce a risk of a security event occurring in the first computing environment, such as generating a notification to the first owner relating to the identification of the reference to the resource name.

### BACKGROUND

In various computing environments, entities utilize resources offered by a third party, such as a cloud provider. During configuration, an entity selects a name for the resource. In many implementations, the selected name for the resource must be unique among all of names for a given type of resource offered by the provider. For instance, where the provider is a cloud provider that has multiple tenants, the selected name must be unique across all of the tenants. In this manner, only a single resource with a particular name is present at a given time for resources offered by the cloud provider.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Systems, methods, and computer readable storage mediums are disclosed herein for mitigating a security risk. In an example system, a resource ownership mapping is obtained that contains ownership information for resource names. For instance, the resource ownership mapping maps a resource name to a history of ownerships of the resource name and an action associated with the resource name. In an example, the history of ownerships includes a first owner. From the resource ownership mapping, a first ownership change of the resource name relating to the first owner is determined. A reference to the resource name in a first computing environment associated with the first owner is identified. A preventative action is performed to reduce a risk of a security event occurring in the first computing environment, such as generating a notification to the first owner relating to the identification of the reference to the resource name.

Further features and advantages of the embodiments, as well as the structure and operation of various embodiments, are described in detail below with reference to the accompanying drawings. It is noted that the claimed subject matter is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments of the present application and, together with the description, further serve to explain the principles of the embodiments and to enable a person skilled in the pertinent art to make and use the embodiments.

FIG. 1 shows a block diagram of a system for mitigating a security risk, in accordance with an example embodiment.

FIG. 2 block diagram of a system for mitigating a security risk in a computing environment, in accordance with another example embodiment.

FIG. 3 shows a flowchart of a method for mitigating a security risk, in accordance with an example embodiment.

FIG. 4 shows a flowchart of a method for generating the resource ownership mapping based on resource name operations, in accordance with an example embodiment.

FIG. 5 shows an example resource ownership mapping that contains a resource name ownership history, in accordance with an example embodiment.

FIG. 6 shows a flowchart of a method for performing a preventative action following a second ownership change of a resource name, in accordance with an example embodiment.

FIG. 7 shows a flowchart of a method for analyzing a sub-resource identifier related to the resource name, in accordance with an example embodiment.

FIG. 8 shows a block diagram of an example computer system in which embodiments may be implemented.

The subject matter of the present application will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION

### I. Introduction

The following detailed description discloses numerous example embodiments. The scope of the present patent application is not limited to the disclosed embodiments, but also encompasses combinations of the disclosed embodiments, as well as modifications to the disclosed embodiments. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Example Embodiments

In various computing environments, entities utilize resources offered by a third party, such as a cloud provider. During configuration, an entity selects a name for the resource. In many implementations, the selected name for the resource must be unique among all of names for a given type of resource offered by the provider. For instance, where the provider is a cloud provider that has multiple tenants, the selected name must be unique across all of the tenants. In this manner, only a single resource with a particular name is present at a given time for resources offered by the cloud provider.

In some environments, a user can delete a resource name, such as when the user no longer needs to use the resource or has selected a different name. When this happens, the cloud provider often allows another user to configure a new resource using the same resource at a later time (e.g., after a cooling off period). For instance, if a user A from an organization X deletes a particular resource (and its associated resource name), the name of that resource would be available for use by a different user B from a different organization Y.

The ability to reuse previously used resource names, however, poses a security risk, such as by allowing reassigned resources to be used by malicious actors to attack resources of the original organization that previously used the resource name. For instance, in the above example, user B of organization Y can make a malicious file publicly accessible under the same resource name that was previously used by organization X. If there are computing devices of organization X that are still configured to access content using the same resource name (i.e., that is no longer used by organization X), those computing devices of organization X could access the malicious code and become infected thereafter. Depending on the type of malicious code, the harm to the computing devices of organization X could be far-reaching (e.g., a breach of sensitive data, creating exploitable attack paths, embedding ransomware, infecting content with viruses, etc.). Thus, these mechanisms raise the risk of harm to computing devices, networks, and data stored on storage devices.

Embodiments described herein are directed to mitigating a security risk. In an example system, a resource ownership mapping is obtained that contains ownership information for resource names. For instance, the resource ownership mapping maps a resource name to a history of ownerships of the resource name and an action associated with the resource name. In an example, the history of ownerships includes a first owner. From the resource ownership mapping, a first ownership change of the resource name relating to the first owner is determined. A reference to the resource name in a first computing environment associated with the first owner is identified. A preventative action is performed to reduce a risk of a security event occurring in the first computing environment, such as generating a notification to the first owner relating to the identification of the reference to the resource name.

Mitigating a security risk as described herein has numerous advantages, including but not limited to improving the security of resources stored on a cloud and/or accessible via computing devices, improving the security of computing devices generally, and improving the security of a network coupled thereto. For example, by determining that a computing environment has references (e.g., artifacts) to a resource with a resource name that is no longer owned or under the control of the organization associated with the computing environment, preventative measures can be implemented to prevent that reference from being used in a manner that causes a security event, such as a breach, infection with malware, or other nefarious activities. For instance, the owner of organization (including any individuals responsible for managing and/or configuring the organization's resources) can be notified to make changes to the computing environment or computing devices within the environment to prevent the previously owned resource name from being utilized altogether. By reducing or eliminating the risk of such a resource name from being used, security events can be reduced or even prevented. Thus, the security of computing devices that store and/or provides the ability to access such resources (including organizational computers and the computing devices of the cloud provider) is improved. In addition, the security of the resources (including services, data, etc.) is also improved by reducing or eliminating the risk of a security event relating to a reuse of a resource name.

In addition to advantageously enabling improvements to the security of resources, the described techniques also enable improvements in the network that provide access to such resources. For instance, by identifying potential security issues arising from references in a computing environment to previously owned (but not currently owned) resource names, a computing environment is protected from being infected with malware that creates additional exploits within the computing environment (e.g., allowing unauthorized access of the computing environment via a network coupled thereto, using malicious code). Thus, techniques described herein overall enables a reduction in potential malicious activity occurring with respect to computing devices, data stored on storage devices, and networking devices coupled to the computing devices). These advantages are only illustrative, and other advantages and/or benefits are described below.

In addition, techniques disclosed herein enable a reduction in processing cycles with respect to security event mitigation and/or remediation. For example, various embodiments described herein allow for the detection of potential security risks in a computing environment (e.g., based on continued usage of a resource name that is no longer owned) before a security event actually occurs. In other words, disclosed techniques allow for early detection of security risks and the performance of one or more preventative measures to prevent the occurrence of a widespread security issue (e.g., an infection of malware across devices, etc.). By reducing the risk of a security event from occurring relating to the reuse of resource names, processing cycles relating to the resolution of such a security event (e.g., post-breach resolution activities) can be reduced or even avoided. In other words, since the likelihood of a security event occurring is reduced, the processing required to address such security events (e.g., scanning devices, installing anti-virus solutions, patching computers and/or networks, etc.) can also be reduced. Thus, early detection of potential security risks enables an overall reduction of compute resources expended in a computing environment.

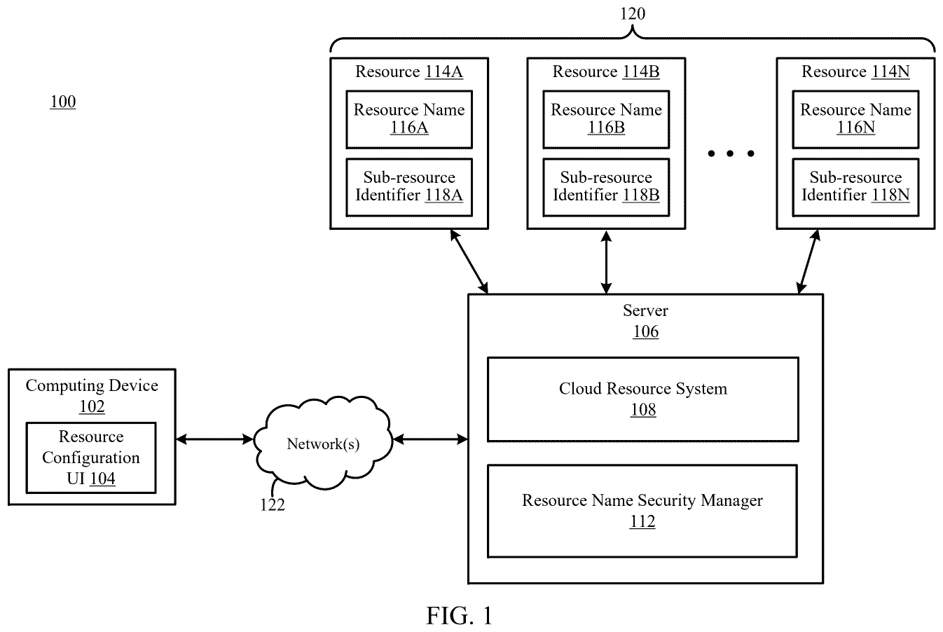

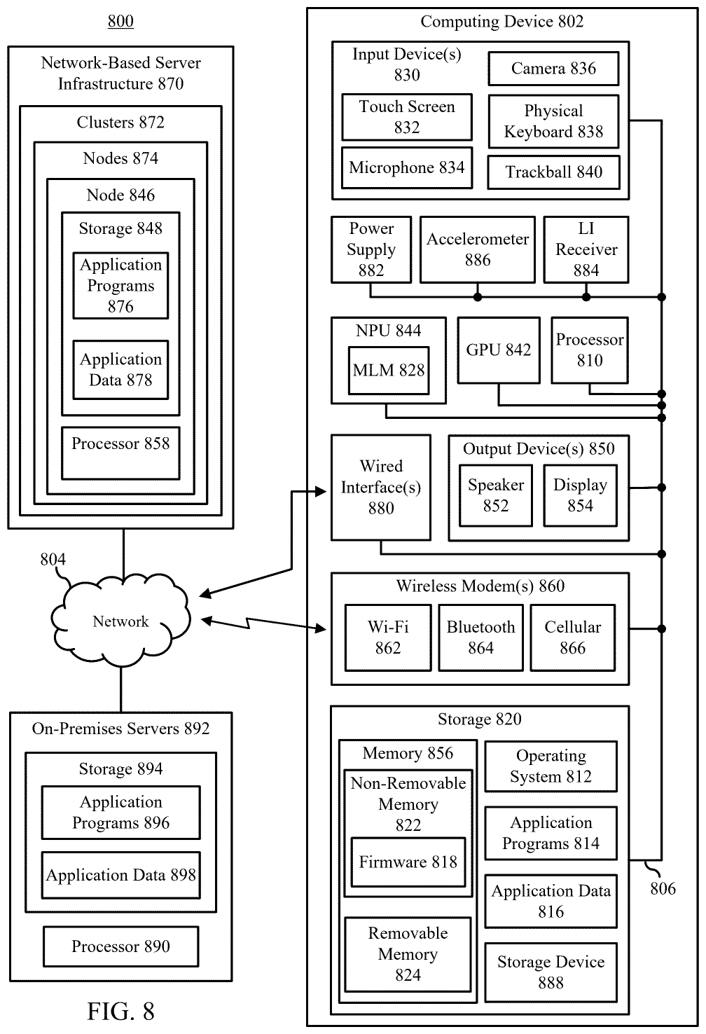

Embodiments for mitigating a security risk are implemented in various way. For instance, FIG. 1 shows a block diagram of system 100 for mitigating a security risk, in accordance with an example embodiment. As shown in FIG. 1, system 100 includes a computing device 102, a server 106, and a set of resources 114A, resource 114B, . . . , resource 114N. In FIG. 1, computing device 102 and server 106 are communicatively coupled via a network 122. Computing device 102 includes a resource configuration user interface (UI) 104. Server 106 includes a cloud resource system 108 and a resource name security manager 112. Resource 114A includes a resource name 116 and a sub-resource identifier 118A. Resource 114B includes a resource name 116B and a sub-resource identifier 118B. Resource 114N includes a resource name 116N and a sub-resource identifier 118N. Collectively, resources 114A-114N are referred to herein as a resource set 120. An example device that incorporates the functionality of computing device 102 and/or server 106 (or any subcomponents therein, whether or not illustrated in FIG. 1) is described below in reference to FIG. 8. It is noted that system 100 comprises any number of devices in example embodiments, including those illustrated in FIG. 1 and optionally one or more further devices or components not expressly illustrated. System 100 is further described as follows.

In an example implementation, network 122 includes one or more of any of a local area network (LAN), a wide area network (WAN), a personal area network (PAN), a combination of communication networks, such as the Internet, and/or a virtual network. In example implementations, computing device 102 and/or server 106 communicate via network 122. In an implementation, any one or more of computing device 102 and/or server 106 communicate over network 122 via one or more application programming interfaces (API) and/or according to other interfaces and/or techniques. In an example, computing device 102 and/or server 106 each include at least one network interface that enables communications with each other. Examples of such a network interface, wired or wireless, include an IEEE 802.11 wireless LAN (WLAN) wireless interface, a Worldwide Interoperability for Microwave Access (Wi-MAX) interface, an Ethernet interface, a Universal Serial Bus (USB) interface, a cellular network interface, a Bluetooth™ interface, a near field communication (NFC) interface, etc. Further examples of network interfaces are described elsewhere herein.

In examples, computing device 102 comprises any one or more computing devices, servers, services, local processes, remote machines, web services, etc. for interacting with one or more resources of resource set 120. In various embodiments, computing device 102 comprises programming instructions executable thereon that enables a user of computing device 102 to interact with one or more of such resources. Such interaction includes, but is not limited to, managing, configuring, viewing, creating, deleting, changing, or otherwise accessing a resource or configuration information related thereto. In examples, computing device 102 is configured to execute resource configuration UI 104, such as by executing executable code (e.g., software) installed on computing device 102, a web browser, or other code that launches resource configuration UI 104. In some implementations, resource configuration UI 104 is accessible via a cloud.

In examples, computing device 102 comprises any type of stationary or mobile computing device, including a mobile computer or mobile computing device (e.g., a Microsoft® Surface® device, a personal digital assistant (PDA), a laptop computer, a notebook computer, a tablet computer, a netbook, etc.), a desktop computer, a server, a mobile phone or handheld device (e.g., a cell phone, a smart phone, etc.), a wearable computing device (e.g., a head-mounted device including smart glasses, a smart watch, etc.), an Internet-of-Things (IOT) device, or other type of stationary or mobile device. Computing device 102 is not limited to a physical machine, but include other types of machines or nodes, such as a virtual machine in various examples. In accordance with an embodiment, computing device 102 is associated with a user (e.g., an individual user, a group of users, an organization, a family user, a customer user, an employee user, an admin user (e.g., a service team user, a developer user, a management user, etc.), etc.). In an example, computing device 102 interfaces with other components illustrated in FIG. 1 through APIs and/or by other mechanisms.

Resource configuration UI 104 comprises an interface that enables interaction between computing device 102 and a resource of resource set 120. For instance, resource configuration UI 104 comprises one or more user interactive controls (e.g., buttons, menus, alphanumeric input fields, icons, windows, etc.) that enables a user of computing device 102 to interact with a resource. In some examples, resource configuration UI 104 comprises one or more user interactive controls that enables interaction with cloud resource system 108 and/or resource name security manager 112 (including but not limited to configuration of the functionalities described herein). In various other examples, resource configuration UI presents information generated by resource name security manager 112, such as notifications and/or recommended actions to mitigate a security risk. Additional details regarding the operation and/or functionality of resource configuration UI 104 are described elsewhere herein.

Server 106 comprises any number of computing devices such as a network-accessible server (e.g., a cloud computing server network), services, local processes, remote machines, web services, etc. for hosting, managing, and/or providing access to any one or more resources in resource set 120 (including the security thereof). In an example, server 106 comprises a group or collection of servers (e.g., computing devices) that are each accessible by a network such as the Internet (e.g., in a “cloud-based” embodiment). In example embodiments, server 106 is a computing device that is located remotely (e.g., in a different facility) from computing device 102. Server 106 comprises any number of computing devices, and includes any type and number of other resources, including resources that facilitate communications with and between servers, storage by the servers, etc. (e.g., network switches, storage devices, networks, etc.). In embodiments, devices of server 106 be co-located (e.g., housed in one or more nearby buildings with associated components such as backup power supplies, redundant data communications, environmental controls, etc.) to form a datacenter, or are arranged in other manners. Accordingly, in an embodiment, server 106 is a datacenter in a distributed collection of datacenters.

Cloud resource system 108 is configured to comprises any combination of hardware and/or software to host, manage, and/or provide access to resources 114A-114N of resource set 120. In various examples, cloud resource system 108 receives one or more user inputs (e.g., from resource configuration UI 104) to create, delete, and/or change a resource. In one example, cloud resource system 108 receives a user input to create, delete, and/or change the name of a resource. In various embodiments, cloud resource system 108 is configured to enable resource configuration UI 104 to manage content, applications, executables, etc. stored in and/or accessible by resource set 120.

In some example embodiments, cloud resource system 108 comprises a system utilized by a plurality of different tenants (e.g., subscribers that are unaffiliated with each other). For instance, cloud resource system 108 hosts, manages, and/or provides access to resources 114A-114N for a plurality of tenants, such as different domains, organizations, clients, employers, etc. Thus, in example embodiments, resources 114A-114N are associated with a plurality of tenants (e.g., different clients or customers, such as different organizations) of a cloud services provider (e.g., an entity that manages cloud resource system 108). In one example, resources of resource set 120 comprise resources associated with (e.g., under the control of) a plurality of unrelated or independent tenants, such as resources of companies lacking any meaningful business relationship with each other. In an illustration, resources 114A-114N comprise one or more software resources (e.g., SaaS, PaaS, etc.), storage resources, databases, etc. that are shared, at least partially, across different tenants.

Resources 114A-114N comprise any type of software or hardware component of a computer (or a combination thereof) that is accessed or utilized by one or more entities and/or in one or more computing environments. In various examples, resources 114A-114N comprise cloud resources of a cloud provider. In some examples, a resource comprise a storage (such as a cloud storage) that contains a collection of information or data that is stored therein. In another example, a resource comprises an account (e.g., a subscription) to a service, such as a storage account. In another example, a resource comprises an application service that is configured to execute a set of executable code. In another example, a resource comprises a registry service in which a subscriber builds, stores, and/or manages container images or artifacts. In another other example, a resource includes one or more physical or virtual components of a computing device for processing information (e.g., a processor). In examples therefore, resource set 120 includes, but is not limited to, a computer or processor, a physical host, a virtual machine, software (e.g., software as a service (SaaS), a platform as a service (PaaS), etc.), licenses, devices (including network devices), a memory or storage (e.g., physical storage devices, local storage devices, cloud-based storages, disks, hard disk drives, solid state devices (SSDs), random access memory (RAM) devices, etc.), data stored within a storage (e.g., files, databases, etc.) or any other component or data of a computing environment that is accessed or utilized by one or more entities.

Resource names 116A-116N each comprise an identifier that identifies a respective resource (e.g., resources 114A-114N). In examples, the identifier comprises a string of characters, which can include text, numbers, special characters, etc. In accordance with various embodiments, a resource name is selected via resource configuration UI 104 (e.g., by an owner or potential owner of a resource). For example, the resource name is received via a user input. In another example, the resource name is generated by cloud resource system 108. As discussed herein, in various embodiments, resource names 116A-116N are unique across a plurality of tenants. For instance, for a given type of resource (e.g., storage accounts), resource names are unique across the set of resources such that two or more resources cannot share the same resource name. In various examples, cloud resource system 108 prevents duplicate resource names from existing across resource set 120 at a given point in time. In some implementations, cloud resource system 108 allows resource names that have been deleted (e.g., by a previous owner) to be reused by a subsequent owner, such as after a cooling-off period has passed in which the resource name is unavailable for use.

As used herein, “own” (including any permutations of such term, such as owner, ownership, etc.) is not limited to a strict ownership of a resource name. Rather, the term “own” with respect to a resource name includes controlling and/or causing to control the management and/or configuration of a resource name and/or associated resource, having the resource name assigned to a given entity (e.g., user, organization, tenant, etc.) such as by a cloud provider, or other forms in which a particular entity is associated with a resource name.

Sub-resource identifiers 118A-118N each comprise an identifier of a resource within another resource (e.g., a resource within one of resources 114A-114N). In examples, the identifier comprises a string of characters, which can include text, numbers, special characters, etc. In various examples, the sub-resource identifiers identify data that is stored within and/or accessible via resources 114A-114N. Such data includes, but is not limited to, files, databases, documents, videos, images, scripts, source code, binary code, executables, etc. In an illustration, where a resource (e.g., resource 114A) comprises a storage account, the sub-resource identifier identifies a file stored in the storage account. In some example embodiments, a sub-resource identifier comprises an extension (e.g., a file extension) and/or a hierarchal structure (e.g., one or more folder names).

Note that the variable “N” is appended to various reference numerals for illustrated components to indicate that the number of such components is variable, with any value of 2 and greater. Note that for each distinct component/reference numeral, the variable “N” has a corresponding value, which may be different for the value of “N” for other components/reference numerals. The value of “N” for any particular component/reference numeral may be less than 10, in the 10 s, in the hundreds, in the thousands, or even greater, depending on the particular implementation.

In various examples, cloud resource system 108 utilizes resource names that are unique across resource set 120. For instance, for a given type of service or a collection of services (e.g., a storage account in an example), cloud resource system 108 requires a unique name for the resource such that only one tenant across a plurality of tenants (e.g., all tenants of cloud resource system 108) owns the resource name at a particular instance in time. For instance, if the resource name “my-storage” is owned by organization X at a particular point in time, another organization Y cannot own the same resource name at the same point in time. In this manner, cloud resource system 108 manages the set of resources such that only a single resource (e.g., of a resource type) exists with a particular name at particular point in time. In other words, cloud resource system 108 ensures that resource names 116A-116N are unique across the plurality of tenants.

In some embodiments, cloud resource system 108 correlates each resource name of resource names 116A-116N with a particular tenant identifier (ID) that is selected by a tenant and/or automatically generated. However, in various examples, the resource name of a given resource is not dependent on the tenant ID (e.g., the resource name is selected such that it is unique across a plurality of tenants, rather than unique only within a given tenant).

In various examples, cloud resource system 108 comprises a portal (e.g., a web-based or cloud-based portal) via which resources 114A-114N are accessed (e.g., by resource configuration UI 104 or via another resource accessing interface). In some examples, the portal is accessed via one of resource names 116-116N. In examples, the portal access is not dependent on a tenant identifier associated with the resource name (e.g., the address for accessing the portal does not include an identification of the tenant). In one illustrative example, cloud resource system 108 exposes an external endpoint that allows users of computing device 102 (or other computing devices not shown) to access any one of resources 114A-114N using Hypertext Transfer Protocol (HTTP) or other protocols that identify the resource name.

In accordance with various embodiments, a resource name comprises an identifier that includes a string of characters that is associated with a resource, such that the resource is identified (e.g., accessed) using its corresponding resource identifier. In examples, a resource name comprises an identifier that is unique from other resource names, such that the same resource name cannot be used (e.g., by multiple tenants) at the same time to map to different resources. In other words, a resource name is different from other resource names at any given instant in time in implementations, where each resource name maps to a different resource. For instance, a storage account with the name “my-storage” would cause cloud d resource system 108 to expose an address such as “my-storage.blob.core.windows.net.” This example is only illustrative, and other types of access of a resource are contemplated in which the access identifies the resource name (and/or does not identify a tenant associated with the resource name).

In accordance with example embodiments, cloud resource system 108 is configured to permit public access to any one or more of the resources of resource set 120. For instance, such public access comprises anonymous access and/or unauthenticated access in which an accessor (e.g., a requestor of the resource) can access the resource without providing any credentials, identity authentication, or satisfy any other requirement as a prerequisite for accessing the resource. In examples, the configuration to permit public access of a resource is provided via resource configuration UI 104 (e.g., by an owner of the resource).

In this manner, cloud resource system 108 allow communication and/or access to any one or more resources without prerequisites or authentication in various examples. For example, a resource owned by a first organization is able to configure the resource to be accessed by accessors associated with a second organization that is unaffiliated with the first organization.

In various embodiments, resource name security manager 112 is configured to identify potential security risks associated with resource names that were previously used (but no longer owned) by a particular tenant. For instance, resource name security manager 112 is configured to maintain an ownership mapping that identifies an ownership history of resource names (e.g., resource names and an associated tenant that owns, or previously owned, the resource names). In an example, resource name security manager 112 determines if a computing environment associated with a previous owner of a resource name continues to reference the resource name. If the computing environment continues to reference the resource name that was previously owned, resource name security manager 112 is configured to perform a security measure to mitigate the risk of a security event occurring in the computing environment, such as by generating a notification to the previous owner indicating that the resource name is still used in the computing environment.

In another example, resource name security manager 112 is configured to determine that a second owner (a subsequent owner) has claimed ownership of a resource name that was previously owned by a first owner and has configured access of the resource in such a manner that allows computing devices associated with the first owner to access the resource without authentication. In such an example, resource name security manager 112 is configured to perform a preventative measure such as by generating a notification to the first owner indicating that a subsequent owner owns a resource that the first owner is still referencing in its computing environment. Various other preventative measures are possible, as will be described elsewhere herein. Additional details regarding the operation and/or functionality of resource name security manager 112 are described below.

Implementations are not limited to the illustrative arrangement shown in FIG. 1. For instance, any of the components shown in FIG. 1 are located in a same computing device, are co-located, or are located remote from each other. Furthermore, system 100 comprises any number of other devices, networks, servers, and/or computing devices coupled in any manner in various embodiments.

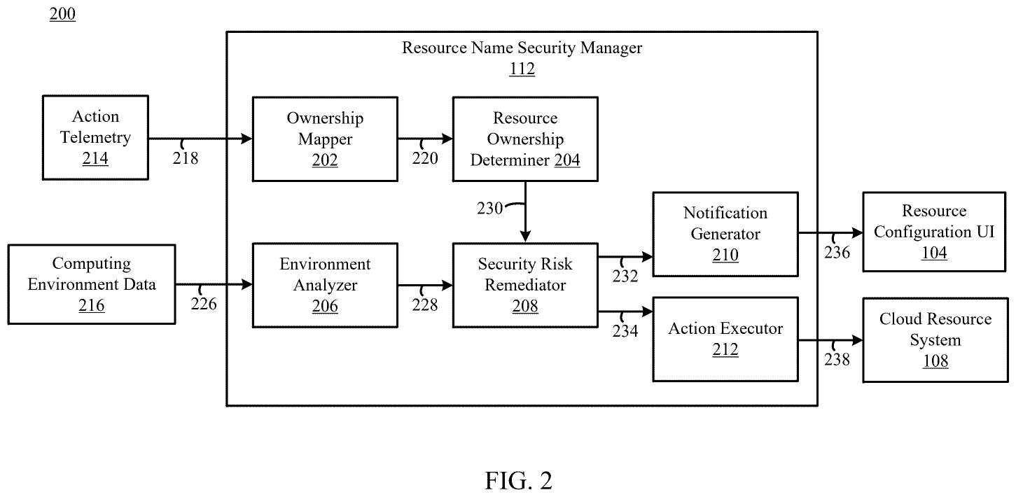

FIG. 2 depicts a block diagram of a system 200 for mitigating a security risk in a computing environment, in accordance with another example embodiment. As shown in FIG. 2, system 200 includes an example implementation of resource configuration UI 104, an example implementation of cloud resource system 108, an example implementation of resource name security manager 112, an action telemetry 214, and computing environment data 216. As shown in FIG. 2, resource name security manager 112 comprises an ownership mapper 202, a resource ownership determiner 204, an environment analyzer 206, a security risk remediator 208, a notification generator 210, and an action executor 212.

In accordance with an embodiment, action telemetry 214 comprises a telemetry of actions performed with respect to resources of resource set 120. In various embodiments, action telemetry 214 represents a history of actions performed with respect to any of resources of resource set 120. In various examples, such actions are performed by an owner (e.g., a tenant, an administrator, etc.) of the resource, such as via resource configuration UI 104. In embodiments, an action comprises an operation relating to one of resource names 116A-116N. In an implementation, action comprises an operation received via a UI (e.g., resource configuration UI 104) relating to the configuration of a resource name. In one example, the operation is a command to be executed by cloud resource system 108 relating to a resource provided by the system, such as an existing resource or a new resource. For instance, at least some actions in action telemetry 214 comprise an operation to create a resource, create a resource name, delete a resource (e.g., an existing resource), delete a resource name, modify a resource, and/or a modify an existing resource name. In various other examples, an action comprises any operation performed that defines and/or alters the manner in which a resource is accessed (e.g., via a corresponding resource name).

In some implementations, the action comprises additional information associated with an action, such as a tenant identifier associated with the action, a timestamp when the action occurred, an identification of a corresponding resource or resource type, or other information associated with the configuration and/or management of a resource name and/or associated resource (e.g., any of resources 114A-114N and/or resource names 116A-116N).

In various embodiments, action telemetry 214 comprises information associated with one or more sub-resource identifiers 118A-118N. For example, action telemetry 214 comprises information indicating that a sub-resource (e.g., a particular file, image, etc.) with a particular sub-resource identifier was stored in, pushed to, added to, and/or removed from one of resources 114A-114N. As an illustration, action telemetry 214 is configured to indicate that a particular image (a sub-resource identifier) was stored in a container registry (a resource) associated with a particular resource. In some examples, any other information associated with such information is also stored, such as a tenant identifier, a timestamp, etc.

In various examples, the action telemetry 214 comprises information obtained from a log (e.g., an event log, a transaction log, an event log, etc.) that is maintained and/or accessible by cloud resource system 108. For example, each time an action occurs, the action (and/or any associated information as described herein) is logged in a table, database, or other data structure. In such an example, action telemetry 214 comprises information stored in such a log. In some other implementations, action telemetry 214 obtains an identification of an action (and/or associated information) from cloud resource system 108 upon occurrence of the action (e.g., without accessing a log), such as in real-time or near real-time. In yet other examples, action telemetry 214 obtains an action (and/or associated information) by accessing and/or using one or more APIs (e.g., an API call to cloud resource system 108). For instance, action telemetry 214 comprises information obtained by tracking one or more cloud API calls relating to operations performed with respect to any of the resources of resource set 120.

Ownership mapper 202 is configured to obtain a telemetry 218 that comprises information from action telemetry 214 and generate a resource ownership mapping 220 that identifies, among other things, a resource name and one or more owners of the resource name (e.g., previous and/or subsequent owners). In this manner, resource ownership mapping 220 comprises information indicative of a history of ownerships of resource names 116A-116N across a plurality of tenants based on monitoring activities across the resources.

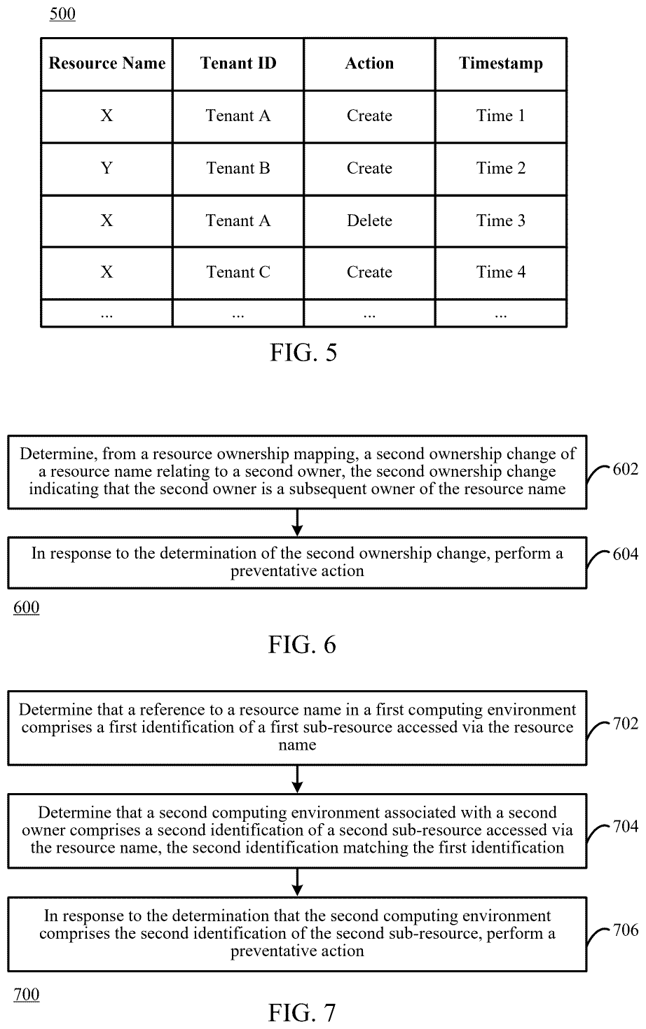

In examples, resource ownership mapping 220 comprises any suitable data structure, such as a database, table, spreadsheet, document, listing, log, etc. In one illustration, ownership mapper 202 generates resource ownership mapping 220 with one or more of the following fields: a resource name, a tenant identifier, an operation (e.g., creation, deletion, and/or modification of a resource name), and/or an operation time (e.g., a timestamp). In some implementations, a timestamp is not included in resource ownership mapping 220. Rather, the operations are listed in chronological order in one implementation, such that an ownership history of resource names is still maintained. An example of resource ownership mapping 220 is described in further detail below with reference to FIG. 5.

In examples, ownership mapper 202 is configured to generate resource ownership mapping 220 over time as information (e.g., information associated with resource name operations) is obtained from action telemetry 214. In other implementations, ownership mapper 202 is configured to generate an initial ownership mapping based on information obtained from cloud resource system 108 and/or action telemetry 214 (e.g., from one or more logs). In some implementations, ownership mapper 202 is configured to continuously update resource ownership mapping 220 (e.g., by appending information thereto) based on data from action telemetry 214, such that resource ownership mapping 220 is maintained in an up-to-date fashion.

Thus, in various embodiments, information contained in resource ownership mapping 220 identifies, for instance, an owner (e.g., a tenant) of a resource name at any given point in time. In some implementations, resource ownership mapping 220 comprises a snapshot for each resource name, such as by identifying any previous and/or subsequent owners and/or a timestamp for when each owner first owned (e.g., created) and/or ceased to own (e.g., deleted) the resource name. In one illustration, ownership mapping indicates, for each resource name, a tenant ID of the current owner, the date the current owner created the resource name, and/or an identification of the previous owner(s) of the same resource name (and/or the dates of creation/deletion for the previous owner(s)). Various other structures are suitable as will be appreciated by those skilled in the art such that resource ownership mapping 220 indicates one or more previous and/or subsequent owners of a resource name and/or the dates/time when such owners owned the resource name.

In examples, resource ownership determiner 204 is configured to analyze resource ownership mapping 220 and determine information associated with a current ownership of a resource name. In some examples, resource ownership determiner 204 determines an ownership change 230 indicative of a change in ownership of a resource name (e.g., a deletion, a creation, and/or a name change). In one example, resource ownership determiner 204 determines that a resource name was deleted by a previous owner and is currently unowned (e.g., not owned by any subsequent owner). In another implementation, resource ownership determiner 204 determines a current owner of a resource name (e.g., a tenant ID that most recently created the resource). In another example, resource ownership determiner 204 is configured to determine an ownership change of a resource name. For instance, resource ownership determiner 204 determines that a previous owner deleted a resource name and a subsequent owner created a resource with the same resource name (e.g., the subsequent owner reused the same resource name).

In various embodiments, resource ownership determiner 204 identifies a timestamp associated with any one or more of the foregoing. For instance, resource ownership determiner 204 determines that a previous owner deleted a resource name at a first point in time, and/or a subsequent owner created the resource name at a second point in time after the first point in time.

Computing environment data 216 comprises information associated with a particular tenant's computing environment (e.g., a tenant's cloud environment). In examples, a tenant's computing environment comprises one or more resources of a tenant, including but not limited to, storage data, files, software, registries, applications, programming code, etc. that are subscribed to by the tenant, owned by the tenant, or otherwise associated with a tenant. For instance, where the resource set 120 comprises resources for a plurality of tenants in a cloud, a particular tenant's resources comprises a subset of such resources. In embodiments, the computing environment of a tenant comprises a plurality of different types of resources (e.g., storage resources, containers, applications, etc.).

In examples, the computing environment also comprises one or more assets thereof, such as computing devices (including applications or software executing thereon), virtual machines, endpoints, etc. which access any one of the resources of a tenant or another tenant. For instance, a computing device associated with an organization (e.g., a device utilized by an employee, a smartphone, a terminal in an office or retail location, etc.) accesses any cloud resources associated with the tenant (a subset of resource set 120) in an example. Such access includes obtaining content stored in a resource, executing code obtained from a resource, or any other operation in which information in the cloud resource is provided to a computing device and/or modifies the functionality of the computing device.

In some embodiments, computing environment data 216 comprises a reference in a computing environment to a resource name. In various examples, the reference to a resource name comprises connection information indicative of a connection (e.g., a communication link) between an asset of the computing environment and one of resources 114A-114N (such as a resource owned by the tenant). In embodiments, the connection information comprises an identification of a resource name that is owned, or was previously owned by the same tenant (e.g., the tenant associated with the computing environment currently owns or previously owned the resource name). In an example, the connection information comprises information obtained from an inventory that identifies a connection to a resource (e.g., by its corresponding resource name). In another example, the connection information is obtained by analyzing a workload that is running or executing (or has executed in the past or will be executed in the future) in a computing environment of the tenant, where the workload references a resource name that is owned and/or was previously owned by the tenant. In another example, the connection information identifies an image that will be obtained (e.g., pulled or downloaded) from a container registry based on the resource name associated with the container registry.

In some other examples, the connection information is obtained by analyzing whether any computing devices (including virtual machines, endpoints, etc.) in a tenant's computing environment accesses cloud resources based on an identification of a cloud resource (e.g., a type of resource) and/or a resource name. In one implementation, such connection information is obtained by identifying one or more connection strings stored in a computing device that identifies a connection between the computing device and a resource name. Such information is obtained from any one or more locations, including but not limited to, on the computing devices, on resources 114A-114N, and/or on cloud resource system 108 (e.g., on a database stored thereon).

In various embodiments, connection information is obtained based on scanning a tenant's computing environment (such as computing devices in the computing environment or resources of the computing environment) to identify a connection string, also known as a secret in some implementations. In other words, based on such scanning, computing environment data 216 comprises information indicative of links to between one entity (e.g., a computing device or a resource) to a resource name (e.g., one of resource names 116A-116N) that is currently and/or was previously associated with the tenant.

In another example, code scanning is performed (e.g., by cloud resource system 108 and/or by one or more other components) to identify connection information that identifies a resource name, such as by references to a resource name in code, configuration files, logs, etc.

Thus, in various embodiments, computing environment data 216 comprises connection information across multiple platforms (e.g., multiple types of resources), where the connection information identifies a resource name. Such information is accessed and/or obtained from various locations, such as on compute resources, code bases, containers (e.g., Kubernetes containers), etc. For example, the connection information is obtained based on locating a connection string of a storage account (e.g., a resource name of a storage account) that is stored on a disk of a virtual machine. In another example, a uniform resource locator (URL) containing the resource name, or other connection identifier containing the resource name, is located in source code stored in a development environment that is within the computing environment of the tenant.

As an illustration, such connection information indicates that a particular computer is using a storage account with a first resource name. In another example, the connection information indicates that a particular set of source code of an application is using an API hosted on an application service with a second resource name. In yet another example, the connection information indicates that a virtual machine comprises an endpoint that uses a storage account with a third resource name. In yet another example, the connection information indicates that markup language, a configuration file (e.g., YAML or Yet Another Markup Language), or other language stored in a development environment specifies a container using a fourth resource name. Other examples are also contemplated as will be appreciated by those skilled in the relevant arts. In this manner, the connection information indicates a connection between various assets of an organization and resources (e.g., by their respective resource names) accessed by those assets.

In examples, environment analyzer 206 is configured obtain connection information 226 and identify based thereon any assets in a tenant's computing environment that has a link to one or more resource names (e.g., resource names that are currently owned, or were previously owned by the tenant). In some implementations, environment analyzer 206 is configured to identify any asset in the computing environment of a tenant that comprises connection information that is an artifact of a previously owned resource name, such as connection information that identifies a resource name that is no longer owned by the tenant (e.g., a resource name that was deleted by the tenant).

In some implementations, environment analyzer 206 is configured to generate at least a portion of computing environment data 216 (including connection information as described herein) by analyzing a tenant's computing environment. For instance, environment analyzer 206 is configured to identify connection strings and/or secrets, perform code scanning functions, and/or perform other scanning functions to identify connections between assets of a computing environment and resource names that are currently owned and/or were previously owned by a tenant.

While examples are described herein in which a particular tenant's computing environment is analyzed, it should be understood that disclosed techniques are utilized to analyze the computing environments of each of a plurality of tenants (e.g., subscribers) of cloud resource system 108 in implementations. Thus, while examples are described herein relating to analyzing a single tenant, it should be understood that techniques are applicable to analyzing each of a plurality of tenants.

In accordance with an embodiment, security risk remediator 208 is configured to determine whether a potential security risk is present in a tenant's computing environment and/or perform one or more remediation actions in response. For example, security risk remediator 208 obtains ownership information that comprises an ownership change 230 indicative of previous and/or subsequent (e.g., current) owners of resource names and information indicative of a reference 228 to one or more resource name(s) used in each tenant's respective computing environment (e.g., where the resource name is used to indicate a connection between an asset of the computing environment and one of resources 114A-114N). Based on such information, security risk remediator 208 identifies one or more assets in a computing environment of a tenant that accesses (or could access in the future) a resource name that was previously owned by the tenant. In some implementations, the previously owned resource name is not owned by any tenant. In another implementation, the previously owned resource name is owned by a different tenant.

In embodiments, security risk remediator 208 determines whether an asset of a computing environment of a tenant references a resource name no longer owned by the tenant in various ways. In one implementation, security risk remediator compares information indicative of a reference 228 to a resource name and information indicative of an ownership change 230 (e.g., by crossing the information with each other) to identify overlaps between resource names referenced in an environment of a tenant and resource names no longer owned by the same tenant (e.g., based on resource name deletions by the tenant) and/or resource names owned by a different tenant (e.g., based on resource name creations by a different tenant). In examples, security risk remediator 208 performs such an analysis using batch processing techniques (e.g., by analyzing a batch of information at a time).

In this manner, security risk remediator 208 identifies any assets of a computing environment of a tenant that references a resource name (e.g., a workload executing in the computing environment that accesses a container registry using a particular resource name) that is no longer owned (e.g., deleted) by the tenant and/or is owned by a different tenant.

In the event security risk remediator 208 identifies one or more of such assets in a computing environment of a tenant that references a resource name that is no longer owned by the tenant, security risk remediator 208 is configured to perform one or more actions (e.g., preventative or proactive measures) to mitigate the likelihood of a security event occurring in the tenant's computing environment. As used herein, a security event comprises an occurrence of one or more conditions of a computing environment that satisfies a security event criteria. In various implementations, a security event comprises a security incident that raises the risk of a malicious action being performed in a computing environment. In some further implementations, a security event comprises an identification of an actual malicious action that has occurred in the computing environment and action that is potentially malicious. Examples of such security events include, but are not limited to, a breach of sensitive data, creation of exploitable attack paths, embedding of ransomware, infection of a computing environment with viruses or malware, or other nefarious activities carried out by malicious actors.

In one implementation, security risk remediator 208 sends a signal 232 to notification generator 210 to generate a notification 236 to provide to a tenant (e.g., via resource configuration UI 104). In one example, the notification comprises a security recommendation or security alert to resource configuration UI 104 indicating the presence of a previously owned resource name (and/or a connection based thereon) in the tenant's computing environment. In some implementations, the security recommendation is provided to aid in the mitigation of a security event occurring. For example, the security recommendation comprises a recommendation to remove the reference(s) to the resource name in the first computing environment, an identification of one or more particular assets in which the reference was located, a risk level associated with continued usage of the resource name, etc. In some examples, notification 236 comprises an interactive element that, when selected by a user, prevents a connection between an asset of the computing environment and the resource name that was previously owned (e.g., by disabling code, a connection string, etc.). In yet another example, the notification indicates that the previously owned resource name present in the tenant's computing environment is owned by a different tenant (e.g., the resource name has been reused by a different entity following the tenant's deletion of the resource name). These examples are only illustrative, and various other examples are described elsewhere herein.

In another implementation, security risk remediator 208 sends a signal 234 to action executor 212 to execute an action 238. In some implementations, action executor 212 generates action 238 that blocks a connection between the tenant's computing environment and the previously owned resource name (e.g., automatically), such as by preventing such a connection on cloud resource system 108. In such an illustration, action executor 212 prevents a computing environment associated with the tenant from accessing a resource with a resource name that is no longer owned. In another example, the action comprises a removal of the resource name from the tenant's computing environment.

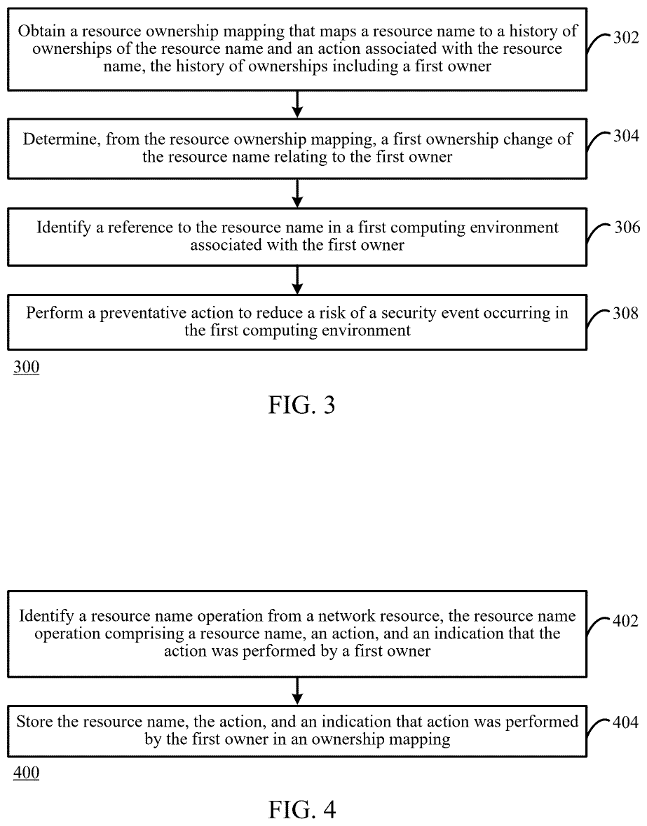

In accordance with one or more embodiments, security is improved when permitting the reuse of resource names. For example, FIG. 3 shows a flowchart 300 of a method for mitigating a security risk, in accordance with an example embodiment. In an embodiment, flowchart 300 is implemented by system 100 as shown in FIG. 1 and/or system 200 as shown in FIG. 2. Accordingly, flowchart 300 will be described with reference to FIGS. 1 and 2. Other structural and operational embodiments will be apparent to persons skilled in the relevant art(s) based on the following discussion regarding flowchart 300, system 100 of FIG. 1 and system 200 of FIG. 2.

Flowchart 300 begins with step 302. In step 302, a resource ownership mapping is obtained that maps a resource name to a history of ownerships of the resource name and an action associated with the resource name. In accordance with an embodiment, the history of ownerships includes a first owner. For instance, with reference to FIGS. 1 and 2, resource ownership determiner 204 is configured to obtain resource ownership mapping 220 that maps a resource name to a history of ownerships of the resource name and an action associated with the resource name. In examples, the history of ownerships in the mapping specifies at least one current and/or previous owner of the resource name. For purposes of illustration, aspects of flowchart 300 (and other flowcharts) will be described with respect to an ownership of resource name 116A. It should be understood that this is only illustrative, and disclosed techniques apply similarly to other resource names.

For example, ownership mapper 202 generates resource ownership mapping 220 that includes a history of ownerships of resource name 116A (in addition to other resource names). In an example, resource ownership mapping 220 indicates that a first owner (e.g., a first tenant) is associated with the resource name. In such an example, resource ownership determiner 204 determines, from the resource ownership mapping 220 that the history of ownerships in the mapping includes the first owner associated with resource name 116A. In an embodiment, resource ownership determiner 204 is also configured to determine an action associated with the resource name, such as an operation indicating that the first owner created the resource name. In some implementations, resource ownership determiner 204 identifies a timestamp associated with such an operation (e.g., when the first owner created resource name 116A). In this manner, resource ownership determiner 204 determines, from the obtained resource ownership mapping, that the first owner owned resource name 116A at some point in time.

In step 304, a first ownership change of the resource name relating to the first owner is determined from the resource ownership mapping. For instance, with reference to FIGS. 1 and 2, resource ownership determiner 204 is configured to determine, from resource ownership mapping 220, a first ownership change of resource name 116A relating to the first owner. Resource ownership determiner 204 determines an ownership change in various ways, as discussed herein. As discussed above, resource ownership mapping 220 is generated based on information obtained from action telemetry 214 corresponding to actions performed with respect to resource names, including but not limited to creations of resource names, deletions of resource names, and modifications of resource names. In various examples, resource ownership determiner 204 determines an ownership change has occurred with respect to a resource name by identifying an entry in resource ownership mapping 220 indicative of a configuration of the resource name. In one example, resource ownership determiner 204 identifies a new ownership of a resource name by identifying an entry (e.g., an action) in resource ownership mapping 220 indicating that a particular tenant (e.g., a new owner) has created a resource name. In such an example, the new ownership comprises an ownership change from an unowned or previously owned resource name to a new ownership of the resource name by the particular tenant.

In another example, resource ownership determiner 204 determines, from the resource ownership mapping 220, an ownership change indicating that an entity (e.g., the first owner) is no longer an owner of resource name 116A. For instance, resource ownership determiner 204 determines such an ownership change by identifying an entry in the resource ownership mapping that indicates that the first owner (e.g., an owner that constituted a new owner in in the previous example) is no longer associated with (e.g., not an owner of) resource name 116A based at least in part on information obtained from action telemetry 214. In one example, resource ownership determiner 204 determines that the first owner is no longer an owner of resource name 116A by identifying an action indicating that the first owner deleted resource name 116A (or changed the resource name to a different resource name). In other words, resource ownership determiner 204 determines, in other implementations, that an ownership change comprises a disowning of a resource name by identifying an entry in resource ownership mapping 220 indicating that a tenant deleted a resource name (and/or deleted a corresponding resource).

In yet other examples, resource ownership determiner 220 accesses resource ownership mapping 220 to identify one or more entries corresponding to a particular resource name (e.g., by searching and/or filtering based on the resource name). Based on the one or more entries, resource ownership determiner 204 determines each prior owner and/or each subsequent owner (if any such prior and/or subsequent owners exist) for a given resource name. In examples, any new ownership of a resource name, any disowning of a resource name, and any change to a resource name constitutes an ownership change.

Thus, in an example, resource ownership determiner 204 determines that a history of ownerships of resource name 116A includes a first owner, and subsequently determines an ownership change associated with the first owner (e.g., indicating that the first owner is no longer an owner of that resource name).

In step 306, a reference to the resource name in a first computing environment associated with the first owner is identified. For instance, with reference to FIGS. 1 and 2, environment analyzer 206 is configured to identify a reference to resource name 116 in a computing environment associated with the first owner. As discussed above, a computing environment associated with an owner (e.g., a tenant) includes any computing asset under the control of the owner, owned by the owner, and/or otherwise associated with the owner (e.g., connected to a network associated with the owner, accesses services of the owner, etc.). In examples, the computing environment includes computing devices (including VMs), resources (e.g., cloud resources), software, networks, etc. associated with the owner.

In an embodiment, environment analyzer 206 identifies a reference to resource name 116A in the computing environment associated with the first owner in various ways, as described elsewhere herein. For instance, environment analyzer 206 identifies resource name 116A in connection string, a secret, in code, or in any other information indicative of a connection between an asset and resource name 116A. As an illustration, the reference to resource name 116A comprises a connection string on a computing device associated with the first owner to a storage resource with the resource name.

In one implementation, the reference to resource name 116A in the computing environment associated with the first owner comprises an outdated reference. For instance, the reference to resource name 116A is identified as being present in the computing environment at a time after the first owner no longer owns the resource name, such that the reference is indicative of a continued use of the resource name during the first owner's ownership of the resource name and after the first owner was no longer an owner of the resource name. In some implementations, the reference was introduced in the computing environment at a time when the first owner owned the resource name. In another implementation, the reference was introduced after the first owner deleted the resource name (such as by a developer or team that was unaware of the deletion).

By identifying such instances in which the resource name is being used in the computing environment associated with the first owner following the deletion of the resource name by the first owner, security risks are identified, such as a potential access of a cloud resource with the no longer owned resource name, where such access is potentially malicious (e.g., a subsequent owner has made malicious content publicly available using the same resource name).

In step 308, a preventative action is performed to reduce a risk of a security event occurring in the first computing environment. For instance, with reference to FIG. 2, security risk remediator 208 is configured to perform a preventative action to reduce a risk of a security event occurring in the first computing environment. In examples, the preventative action comprises various types of operations, such as causing notification generator 210 to generate a notification to the first owner as a security recommendation. In one implementation, the notification indicates that resource name 116A is no longer owned by the first owner but is still referenced in its computing environment. In another implementation, the notification comprises a recommendation to remedy the security issue, such as a recommendation to delete the resource name from the computing environment (e.g., by deleting or removing any connection information in the computing environment that references resource name 116A).

In another example, the preventative action comprises selecting an operation (e.g., an automated operation) to be performed by action executor 212 to prevent or otherwise hinder access of a resource with resource name 116A, such as by removing connection information the references the resource name, blocking network access of a resource with the resource name, etc.

Thus, even after a tenant ceases to own a particular resource name, old or stale references to that resource name in the tenant's computing environment are identified such that the risk of a security event (e.g., a breach or other malicious activity) occurring as a result of the continued use of the resource name is reduced. In various embodiments, such preventative measures are performed even before a subsequent owner claims ownership of the resource name, thus enabling the first owner to remedy potential security issues before the risk of a threat substantially increases. In other words, disclosed techniques allow for remedying security issues before an actual vulnerability or exploit occurs in the computing environment, thereby improving the overall security of the computing environment in addition to various other advantages described elsewhere herein. In various implementations, techniques disclosed herein are utilized as part of a Cloud Security Posture Management (CSPM) system in which potential issues relating to cloud resources are identified and/or remediated before a security event (e.g., a breach) occurs.

Accordingly, disclosed techniques allow for various improvements with respect to resource name reuse, and in particular, resource name reuse that results in potential resource hijacking or a sub-domain takeover by malicious actors (e.g., reusing resources in a nefarious manner). By leveraging large scale visibility of a cloud provider (e.g., cloud resource system 108) that has access to resource name ownership, ownership changes, and connection information (e.g., based on cloud API monitoring, connection strings, code scanning, secret scanning, or other capabilities) that relies upon resource names, potential security risks in a computing environment are readily identified and/or remediated in example embodiments. Not only do such techniques result in improved security, but they also enable various other benefits as described herein.

It should be noted that any one or more of the functions described herein (e.g., generating a resource ownership mapping, determining the ownership of a resource name, analyzing a computing environment, mitigating the risk of a security event occurring, etc.) are performed periodically (e.g., once an hour, once a day, etc.) and/or based on the occurrence of an event (e.g., an occurrence of an ownership change for a resource name).

As described above, a resource ownership mapping is generated that comprises a history of ownerships of a resource name in embodiments. For example, FIG. 4 shows a flowchart 400 of a method for generating the resource ownership mapping based on resource name operations, in accordance with an example embodiment. In an embodiment, flowchart 400 is implemented by system 100 as shown in FIG. 1 and/or system 200 as shown in FIG. 2. Accordingly, flowchart 400 will be described with reference to FIGS. 1 and 2. Other structural and operational embodiments will be apparent to persons skilled in the relevant art(s) based on the following discussion regarding flowchart 400, system 100 of FIG. 1, and system 200 of FIG. 2.

Flowchart 400 begins with step 402. In step 402, a resource name operation is identified from a network resource, the resource name operation comprising a resource name, an action, and an indication that the action was performed by a first owner. For instance, with reference to FIG. 2, ownership mapper 202 identifies a resource name operation from action telemetry 214. In examples, action telemetry 214 is a network resource, such as one or more computing components, databases, logs, etc. that is coupled to a network and which comprises a history of resource name operations (among other things, as described herein).

In implementations, the resource name operation obtained by ownership mapper 202 is stored as a set of data (e.g., a tuple of information) in a suitable data structure in action telemetry 214. In other examples, the resource name operation is obtained upon occurrence of the name change operation (e.g., in real-time or near real-time), such as by monitoring or initiating a cloud API call. In yet another example, the resource name operation is obtained by otherwise intercepting or accessing a communication provided via resource configuration UI 104 (or other terminal) via which the resource name operation was initiated.

As discussed above, the resource name operation comprises a set of information associated with the changing and/or configuration of a name of a resource, including but not limited to a change in an ownership of a resource name. In examples, the resource name operation comprises an identification of the resource name on which the operation is performed, an action performed with respect to the resource name, and an identification of an owner (e.g., tenant) associated with the action. In examples, the identification of the owner associated with the action comprises an indication that the action was performed by a particular owner (e.g., by identifying the tenant ID or other identifier associated with the owner).

Accordingly, each resource name operation obtained by ownership mapper 202 comprises a resource name (e.g., Resource X), an action (e.g., creation of a resource), and an identification of an owner (e.g., Tenant A). In some examples, the resource name operation also comprises a timestamp indicative of the initiation and/or execution time of the resource name operation.

In step 404, storing the resource name, the action, and an indication that action was performed by the first owner in the resource ownership mapping. For instance, with reference to FIG. 2, ownership mapper 202 is configured to store information obtained from action telemetry 214 (e.g., the resource name, the action, and the indication that the action was performed by a first owner) in resource ownership mapping 220. In a further implementation, such as where action telemetry 214 also includes a timestamp associated with name change operations, ownership mapper 202 is also configured to store the associated timestamp in resource ownership mapping 220.

In accordance with an embodiment, ownership mapper 202 is configured to continuously obtain resource name operations in a similar manner as described for a plurality of resources across a plurality of tenants of cloud resource system 108, resulting in the generation of resource ownership mapping 220 that is maintained in a continuously updated fashion. As a result, security risk remediator 208 is configured to assess and/or remediate potential security risks based on a current state of a cloud system (e.g., based on continuously updated ownership information regarding resource names), thereby improving the overall security of the cloud system.

In order to better understand certain aspects of the disclosed techniques, an illustrative resource ownership mapping will be described. For instance, FIG. 5 shows an example resource ownership mapping 500 that contains a resource name ownership history, in accordance with an example embodiment. In an implementation, resource ownership mapping 500 is generated by ownership mapper 202 based on a plurality resource name operations (e.g., as obtained from an action telemetry). In an embodiment, resource ownership mapping 500 is an illustrative example of resource ownership mapping 220.

As shown in FIG. 5, resource ownership mapping 500 comprises a data structure, such as table, with a plurality of fields. In the illustration of FIG. 5, resource ownership mapping 500 comprises a plurality of rows and columns. A first column identifies a resource name, a second column identifies a tenant ID, a third column identifies an action performed with respect to the resource name, and a fourth column identifies a timestamp associated with each action.

As illustrated in FIG. 5, each row in resource ownership mapping 500 comprises information relating to a different resource name operation (e.g., an individual transaction with respect to a resource name) as obtained from a network resource, such as action telemetry 214. For instance, at Time 1, Tenant A created a resource with a resource name X. At Time 2, Tenant B created a resource with a resource name Y. At Time 3, Tenant A deleted the resource with the resource name X. At Time 4, Tenant C created a resource with the resource name X. In the illustration of FIG. 5, resource name X was previously owned by Tenant A and is subsequently owned by Tenant C. In examples, Tenants A, B, and C are unaffiliated with each other.

It should be understood that the arrangement shown in FIG. 5 is only illustrative, and other data structures and/or other arrangements are also contemplated. For instance, resource ownership mapping 500 any more or less information than depicted in FIG. 5. In addition, resource ownership mapping 500 is illustrated in FIG. 5 as a listing of individual transactions in each row. However, the resource name history can be arranged in other manners, such as by identifying a plurality (e.g., all) of the resource name operations corresponding to a given resource name.

In accordance with an embodiment, after Tenant A deletes resource name X (i.e., Tenant A no longer owns resource name X), security remediator 208 determines whether a security risk is present in a computing environment associated with Tenant A based at least on a usage of the resource name X in the environment. For instance, as described herein, environment analyzer 206 is configured to determine whether a computing environment of a tenant contains references to one or more resource names, such as resource names that are no longer owned by the tenant. If environment analyzer 206 determines that the computing environment associated with Tenant A still references resource name X (e.g., based on a connection string, code scanning, etc.) and resource ownership determiner 204 determines that Tenant A no longer owns resource name X, security risk remediator 208 performs a preventative action to mitigate a security risk in Tenant A's computing environment in examples, such as by generating a notification or executing an action as described herein. In examples, such a preventative action is performed prior to Time 4 when Tenant C reuses the resource name X.

In various other implementations, an additional or different type of preventative action is performed after Time 4 when Tenant C creates a resource with the resource name X that was previously owned by Tenant 4. For example, FIG. 6 shows a flowchart 600 of a method for performing a preventative action following a second ownership change of a resource name, in accordance with an example embodiment. In an embodiment, flowchart 600 is implemented by system 100 as shown in FIG. 1 and/or system 200 as shown in FIG. 2. Accordingly, flowchart 600 will be described with reference to FIGS. 1 and 2. Other structural and operational embodiments will be apparent to persons skilled in the relevant art(s) based on the following discussion regarding flowchart 600, system 100 of FIG. 1, and system 200 of FIG. 2. For purposes of illustration, flowchart 600 will also be described with respect to resource ownership mapping 500 as illustrated in FIG. 5.

Flowchart 600 begins with step 602. In step 602, a second ownership change of a resource name relating to a second owner is determined from the resource ownership mapping, where the second ownership change indicates that the second owner is a subsequent owner of the resource name. For instance, with reference to FIG. 2, ownership mapper 202 obtains a resource name operation relating to the resource name and a second owner, and updates resource ownership mapping 220 based on the resource name operation. In implementations, the resource name operation comprises an action performed by a second owner to create a resource with the same resource name that was previously owned by a first owner. For example, the second ownership change comprises a change in ownership of the resource name (e.g., from the resource name being owned by a first owner to the same resource name being owned by a second owner, or from the resource name being unowned to the resource name being owned by the second owner).

In an embodiment, the second owner is a subsequent owner of the resource name. In some implementations, the subsequent owner is also a current owner. However, examples are not limited to such a scenario, as implementations are also contemplated in which there are one or more subsequent owners of the resource name, or that the resource name becomes unowned after it was owned by any owner. In various embodiments, the first owner and the second owner are different (e.g., unaffiliated) tenants of the same cloud provider.

In examples, resource ownership determiner 204 is configured to determine the second ownership change based on the updated resource ownership mapping. For instance, resource ownership determiner 204 determines, from resource ownership mapping 220, that a first owner initially owned a resource name (e.g., created the resource name), subsequently disowned (e.g., deleted) the resource name, and that a second (e.g., subsequent) owner thereafter owned the same resource name.

For illustrative purposes, resource ownership mapping 500 illustrates the foregoing scenario. As shown in FIG. 5, at Time 3, Tenant A (a first owner) deleted a resource with the resource name X. Thus, at Time 3, Tenant A no longer owns the resource name X. In an embodiment, the resource name X becomes unowned at Time 3. In some implementations, cloud resource system 108 prevents any other entity from creating a resource with the same resource name for a predetermined period of time (e.g., a cooling off period, after which the resource name is available for use by another entity.

At Time 4, Tenant C created a resource with the same resource name X as shown in resource ownership mapping 500. In examples, Tenant C is thus a subsequent owner of resource name X, and Tenant A is a previous owner of resource name X. Thus, resource ownership mapping comprises information indicating that an ownership change occurred with respect to resource name X (e.g., from being previously owned by Tenant A to subsequently owned by Tenant C).

In step 604, in response to the determination of the second ownership change, a preventative action is performed. For instance, with reference to FIG. 2, security risk remediator 208 is configured to perform a preventative action in response to a determination of the second ownership change.

In various examples, security risk remediator 208 performs the preventative action following a determination (e.g., by environment analyzer 206) that a computing environment associated with the first owner references the resource name (and/or a connection based on the resource name) that is subsequently owned by the second owner. For instance, where the first owner's computing environment still comprises one or more references to the resource name, security risk remediator 208 determines that such references constitute a security risk since the first owner no longer owns the resource name. For example, the second owner could be an actor that has made malicious content available using the resource name, thus permitting assets of the first owner's computing environment to access such malicious content in an unrestricted fashion. To address such a risk, security risk remediator 208 therefore performs a preventative action to reduce the risk of a security event (e.g., a breach, malware infection, etc.) occurring in the first owner's computing environment.

In another implementation, security risk remediator 208 determines whether the resource created by the second owner with the same resource name is configured in a manner that allows an open access (e.g., anonymous and/or unauthenticated access). If open access is provided, a preventive measure is performed in some examples.

For instance, notification generator 210 generates a notification to the first owner that indicates that the resource name that was previously owned by the first owner is owned by another entity (e.g., a tenant unaffiliated with the first owner). In some implementations, notification 236 provides one or more security recommendations to aid in the mitigation of a security event occurring, as described elsewhere herein. In other examples, as described elsewhere, action executor 212 performs an action (e.g., an automated action) to reduce the risk of a security event occurring.

Continuing with the illustration shown in FIG. 5, the preventative action is performed in an example after Time 4 when Tenant C creates a resource with resource name X. In some implementations, a plurality of preventative actions are performed. For example, a first preventative action is performed after Time 3 (but before Time 4) based at least on a determination that a computing environment still references a previously owned resource name, and a second preventative action is performed after Time 4 when a subsequent owner claims ownership of the same resource name. By implementing different preventative actions based on the current state of the resource name, preventative measures are able to be tailored appropriately (e.g., from a lower severity to a higher severity).

While example embodiments are described herein in which a first and second owner (and/or any additional subsequent owners) comprise tenants that are unaffiliated with each other, disclosed techniques are also utilized in scenarios within a given tenant, such as where a first owner comprises a first entity (e.g., an individual user, a particular team or division, etc.) of a tenant, and a second owner comprises a second entity of the same tenant. In such examples, disclosed techniques are also implemented to identify scenarios in which a resource name previously owned by a first entity is still being used by the first entity, while the resource name is subsequently owned by a second entity in the same organization. These examples are only illustrative, and other scenarios are also contemplated for implementing the disclosed techniques.

In accordance with an embodiment, a risk of a security event occurring in a first owner's computing environment increases depending on a particular usage of the resource name by a second owner. For example, FIG. 7 shows a flowchart 700 of a method for analyzing a sub-resource identifier related to the resource name, in accordance with an example embodiment. In an embodiment, flowchart 700 is implemented by system 100 as shown in FIG. 1 and/or system 200 as shown in FIG. 2. Accordingly, flowchart 700 will be described with reference to FIGS. 1 and 2. Other structural and operational embodiments will be apparent to persons skilled in the relevant art(s) based on the following discussion regarding flowchart 700, system 100 of FIG. 1, and system 200 of FIG. 2.

Flowchart 700 begins with step 702. In step 702, a determination is made that a reference to a resource name in a first computing environment comprises a first identification of a first sub-resource accessed via the resource name. For instance, with reference to FIGS. 1 and 2, environment analyzer 206 determines that a reference to a resource name (e.g., a resource name previously owned by a first owner) in a first computing environment associated with the first owner comprises a first identification of a first sub-resource accessed via the first resource name. In an example, the sub-resource identifier comprises one of sub-resource identifiers 118A-118N.

By way of illustration, the identifier of a sub-resource comprises an identifier of an asset (e.g., a file name, a database name, an image, an executable, etc.) that is accessed via the resource name. For example, where a resource is a storage resource, the resource name is an identifier (e.g., an account name or other identifier) of the storage resource, and the sub-resource identifier comprises an identifier of an individual asset located in the storage resource. In other words, a sub-resource as used herein comprises an asset that is accessible via a resource name, and the sub-resource identifier is a string that identifies the sub-resource such that the sub-resource can be accessed (e.g., by a computing device or other asset in a computing environment).

In examples, therefore, environment analyzer 206 is configured to determine that a resource name is referenced in a computing environment, as well as a sub-resource identifier associated with the resource name that is accessed via the resource name.

In step 704, a determination is made that a second computing environment associated with a second owner comprises a second identification of a second sub-resource accessed via the resource name, where the second identification matches the first identification. For instance, with continued reference to FIG. 2, environment analyzer 206 is configured to determine that a second computing environment associated with a second owner of the resource name (e.g., a subsequent owner as described herein) comprises a second identification of a second sub-resource accessed via the resource name, where the second identification matches the first identification. In other words, environment analyzer 206 determines, in an embodiment, that a first computing environments comprises a reference to a particular sub-resource identifier, and that the second computing environment comprises a sub-resource with the same sub-resource identifier.

By way of illustration, a first computing environment associated with a first owner comprises a reference to a previously owned resource name, where such a reference identifies (or is used to obtain) a particular asset from the resource with the resource name. For instance, the resource comprises a container registry, and the sub-resource identifier comprises an identification of an image that would be obtained from the container registry using the resource name. In this illustration, not only does a second owner subsequently claim ownership of the resource name, the second owner also pushes (or otherwise makes available) an image that has the same sub-resource identifier used in the reference in the first computing environment. Such an example is inferred to constitute malicious activity in some scenarios, given that a combination of the same resource name and same sub-resource identifier used by unaffiliated tenants is uncommon.

In example embodiments, environment analyzer 206 determines the presence of a first identifier and/or second identifier of a sub-resource in various ways. In one implementation, environment analyzer 206 determines the presence of the foregoing (e.g., sub-resource identifiers present in a given computing environment) based on one or more telemetries, logs, code scanning systems, or other sources that identify and/or log identifications of sub-resources in an environment.

In step 706, in response to the determination that the second computing environment comprises the second identification of the second sub-resource, the preventative action is performed. For example, with reference to FIG. 2, security risk remediator 208 is configured to perform one or more preventative actions in response to a determination that the second computing environment comprises the second identification of the sub-resource that matches the first identification. As noted above, such a situation is inferred as an actual security threat in some examples, as the first computing environment comprises a reference (e.g., a connection) that would access a potentially malicious sub-resource from an unaffiliated tenant that has made an asset available with a matching sub-resource identifier.

In examples, the preventative action comprises any of one or more of the preventative actions described herein, such as generating a notification, performing an automated action, or other types of actions to reduce the likelihood of a security event occurring in a computing environment. In this manner, access (and/or execution) of potentially malicious content by a computing environment can be prevented, enabling various benefits as described herein.

An example scenario is described that illustrates certain aspects described herein. For instance, consider a scenario in which end-users of Organization A execute an agent (e.g., “agent.exe” or sub-resource identifier 118A in this illustration) on their respective endpoints (e.g., computing devices). Using a script that is executed on the endpoint, the agent is downloaded from a storage account (e.g., resource 114A with resource name “app-storage” or resource name 116A). In this illustration, Organization A decides to no longer use the resource name “app-storage” and deletes the “app-storage” account. However, in this illustration, Organization A has not modified the script that references “app-storage” to download the agent onto each endpoint. In such an example, disclosed techniques are utilized to determine that the computing environment of Organization A still reference the app-storage to download an agent and perform a preventative measure in response.

In further continuation of this illustration, a subsequent owner (e.g., a malicious actor) creates a new storage account with the same name, “app-storage.” The malicious actor then places a malware named “agent.exe” in the “app-storage” storage account and configures the account such that “agent.exe” is downloadable by others (including users or endpoints of Organization A). In such an example, disclosed techniques are implemented to identify a security risk associated with the same sub-resource identifier used by the malicious actor, and perform a preventative measure to reduce the likelihood of a security event occurring in Organization A's computing environment. In this manner, techniques disclosed herein allow for preventing endpoints associated with Organization A from downloading the malware “agent.exe” from “app-storage” that is no longer owned by Organization A. While this example illustrates certain features of the disclosed techniques, it should be understood that the foregoing example is only illustrative in nature, and various other implementations are contemplated.

### III. Example Mobile Device and Computer System Implementation

Computing device 102, resource configuration UI 104, server 106, cloud resource system 108, resource name security manager 112, resources 114A-114N, resource names 116A-116N, sub-resource identifiers 118A-118N, ownership mapper 202, resource ownership determiner 204, environment analyzer 206, security risk remediator 208, notification generator 210, action executor 212, action telemetry 214, and/or computing environment data 216 are implemented in hardware, or hardware combined with one or both of software and/or firmware. For example, resource configuration UI 104, cloud resource system 108, resource name security manager 112, resources 114A-114N, resource names 116A-116N, sub-resource identifiers 118A-118N, ownership mapper 202, resource ownership determiner 204, environment analyzer 206, security risk remediator 208, notification generator 210, action executor 212, action telemetry 214, and/or computing environment data 216, and/or the components described therein, and/or the steps of flowcharts 300, 400, 600, and/or 700 are each implemented as computer program code/instructions configured to be executed in one or more processors and stored in a computer readable storage medium. Alternatively, resource configuration UI 104, cloud resource system 108, resource name security manager 112, resources 114A-114N, resource names 116A-116N, sub-resource identifiers 118A-118N, ownership mapper 202, resource ownership determiner 204, environment analyzer 206, security risk remediator 208, notification generator 210, action executor 212, action telemetry 214, and/or computing environment data 216, and/or the components described therein, and/or the steps of flowcharts 300, 400, 600, and/or 700 are implemented in one or more SoCs (system on chip). An SoC includes an integrated circuit chip that includes one or more of a processor (e.g., a central processing unit (CPU), microcontroller, microprocessor, digital signal processor (DSP), etc.), memory, one or more communication interfaces, and/or further circuits, and optionally executes received program code and/or include embedded firmware to perform functions.

Embodiments disclosed herein can be implemented in one or more computing devices that are mobile (a mobile device) and/or stationary (a stationary device) and include any combination of the features of such mobile and stationary computing devices. Examples of computing devices in which embodiments are implementable are described as follows with respect to FIG. 8. FIG. 8 shows a block diagram of an exemplary computing environment 800 that includes a computing device 802. Computing device 802 is an example of computing device 102 and/or server 106, which each include one or more of the components of computing device 802. In some embodiments, computing device 802 is communicatively coupled with devices (not shown in FIG. 8) external to computing environment 800 via network 804. Network 804 comprises one or more networks such as local area networks (LANs), wide area networks (WANs), enterprise networks, the Internet, etc. In examples, network 804 includes one or more wired and/or wireless portions. In some examples, network 804 additionally or alternatively includes a cellular network for cellular communications. Computing device 802 is described in detail as follows.

Computing device 802 can be any of a variety of types of computing devices. Examples of computing device 802 include a mobile computing device such as a handheld computer (e.g., a personal digital assistant (PDA)), a laptop computer, a tablet computer, a hybrid device, a notebook computer, a netbook, a mobile phone (e.g., a cell phone, a smart phone, etc.), a wearable computing device (e.g., a head-mounted augmented reality and/or virtual reality device including smart glasses), or other type of mobile computing device. In an alternative example, computing device 802 is a stationary computing device such as a desktop computer, a personal computer (PC), a stationary server device, a minicomputer, a mainframe, a supercomputer, etc.

As shown in FIG. 8, computing device 802 includes a variety of hardware and software components, including a processor 810, a storage 820, a graphics processing unit (GPU) 842, a neural processing unit (NPU) 844, one or more input devices 830, one or more output devices 850, one or more wireless modems 860, one or more wired interfaces 880, a power supply 882, a location information (LI) receiver 884, and an accelerometer 886. Storage 820 includes memory 856, which includes non-removable memory 822 and removable memory 824, and a storage device 888. Storage 820 also stores an operating system 812, application programs 814, and application data 816. Wireless modem(s) 860 include a Wi-Fi modem 862, a Bluetooth modem 864, and a cellular modem 866. Output device(s) 850 includes a speaker 852 and a display 854. Input device(s) 830 includes a touch screen 832, a microphone 834, a camera 836, a physical keyboard 838, and a trackball 840. Not all components of computing device 802 shown in FIG. 8 are present in all embodiments, additional components not shown may be present, and in a particular embodiment any combination of the components are present. In examples, components of computing device 802 are mounted to a circuit card (e.g., a motherboard) of computing device 802, integrated in a housing of computing device 802, or otherwise included in computing device 802. The components of computing device 802 are described as follows.

In embodiments, a single processor 810 (e.g., central processing unit (CPU), microcontroller, a microprocessor, signal processor, ASIC (application specific integrated circuit), and/or other physical hardware processor circuit) or multiple processors 810 are present in computing device 802 for performing such tasks as program execution, signal coding, data processing, input/output processing, power control, and/or other functions. In examples, processor 810 is a single-core or multi-core processor, and each processor core is single-threaded or multithreaded (to provide multiple threads of execution concurrently). Processor 810 is configured to execute program code stored in a computer readable medium, such as program code of operating system 812 and application programs 814 stored in storage 820. The program code is structured to cause processor 810 to perform operations, including the processes/methods disclosed herein. Operating system 812 controls the allocation and usage of the components of computing device 802 and provides support for one or more application programs 814 (also referred to as “applications” or “apps”). In examples, application programs 814 include common computing applications (e.g., e-mail applications, calendars, contact managers, web browsers, messaging applications), further computing applications (e.g., word processing applications, mapping applications, media player applications, productivity suite applications), one or more machine learning (ML) models, as well as applications related to the embodiments disclosed elsewhere herein. In examples, processor(s) 810 includes one or more general processors (e.g., CPUs) configured with or coupled to one or more hardware accelerators, such as one or more NPUs 844 and/or one or more GPUs 842.

Any component in computing device 802 can communicate with any other component according to function, although not all connections are shown for case of illustration. For instance, as shown in FIG. 8, bus 806 is a multiple signal line communication medium (e.g., conductive traces in silicon, metal traces along a motherboard, wires, etc.) present to communicatively couple processor 810 to various other components of computing device 802, although in other embodiments, an alternative bus, further buses, and/or one or more individual signal lines is/are present to communicatively couple components. Bus 806 represents one or more of any of several types of bus structures, including a memory bus or memory controller, a peripheral bus, an accelerated graphics port, and a processor or local bus using any of a variety of bus architectures.

Storage 820 is physical storage that includes one or both of memory 856 and storage device 888, which store operating system 812, application programs 814, and application data 816 according to any distribution. Non-removable memory 822 includes one or more of RAM (random access memory), ROM (read only memory), flash memory, a solid-state drive (SSD), a hard disk drive (e.g., a disk drive for reading from and writing to a hard disk), and/or other physical memory device type. In examples, non-removable memory 822 includes main memory and is separate from or fabricated in a same integrated circuit as processor 810. As shown in FIG. 8, non-removable memory 822 stores firmware 818 that is present to provide low-level control of hardware. Examples of firmware 818 include BIOS (Basic Input/Output System, such as on personal computers) and boot firmware (e.g., on smart phones). In examples, removable memory 824 is inserted into a receptacle of or is otherwise coupled to computing device 802 and can be removed by a user from computing device 802. Removable memory 824 can include any suitable removable memory device type, including an SD (Secure Digital) card, a Subscriber Identity Module (SIM) card, which is well known in GSM (Global System for Mobile Communications) communication systems, and/or other removable physical memory device type. In examples, one or more of storage device 888 are present that are internal and/or external to a housing of computing device 802 and are or are not removable. Examples of storage device 888 include a hard disk drive, a SSD, a thumb drive (e.g., a USB (Universal Serial Bus) flash drive), or other physical storage device.

One or more programs are stored in storage 820. Such programs include operating system 812, one or more application programs 814, and other program modules and program data. Examples of such application programs include computer program logic (e.g., computer program code/instructions) for implementing resource configuration UI 104, cloud resource system 108, resource name security manager 112, resources 114A-114N, resource names 116A-116N, sub-resource identifiers 118A-118N, ownership mapper 202, resource ownership determiner 204, environment analyzer 206, security risk remediator 208, notification generator 210, action executor 212, action telemetry 214, and/or computing environment data 216, and/or each of the components described therein, as well as any of flowcharts 300, 400, 600, and/or 700, and/or any individual steps thereof.

Storage 820 also stores data used and/or generated by operating system 812 and application programs 814 as application data 816. Examples of application data 816 include web pages, text, images, tables, sound files, video data, and other data. In examples, application data 816 is sent to and/or received from one or more network servers or other devices via one or more wired or wireless networks. Storage 820 can be used to store further data including a subscriber identifier, such as an International Mobile Subscriber Identity (IMSI), and an equipment identifier, such as an International Mobile Equipment Identifier (IMEI). Such identifiers can be transmitted to a network server to identify users and equipment.

In examples, a user enters commands and information into computing device 802 through one or more input devices 830 and receives information from computing device 802 through one or more output devices 850. Input device(s) 830 includes one or more of touch screen 832, microphone 834, camera 836, physical keyboard 838 and/or trackball 840 and output device(s) 850 includes one or more of speaker 852 and display 854. Each of input device(s) 830 and output device(s) 850 are integral to computing device 802 (e.g., built into a housing of computing device 802) or are external to computing device 802 (e.g., communicatively coupled wired or wirelessly to computing device 802 via wired interface(s) 880 and/or wireless modem(s) 860). Further input devices 830 (not shown) can include a Natural User Interface (NUI), a pointing device (computer mouse), a joystick, a video game controller, a scanner, a touch pad, a stylus pen, a voice recognition system to receive voice input, a gesture recognition system to receive gesture input, or the like. Other possible output devices (not shown) can include piezoelectric or other haptic output devices. Some devices can serve more than one input/output function. For instance, display 854 displays information, as well as operating as touch screen 832 by receiving user commands and/or other information (e.g., by touch, finger gestures, virtual keyboard, etc.) as a user interface. Any number of each type of input device(s) 830 and output device(s) 850 are present, including multiple microphones 834, multiple cameras 836, multiple speakers 852, and/or multiple displays 854.

In embodiments where GPU 842 is present, GPU 842 includes hardware (e.g., one or more integrated circuit chips that implement one or more of processing cores, multiprocessors, compute units, etc.) configured to accelerate computer graphics (two-dimensional (2D) and/or three-dimensional (3D)), perform image processing, and/or execute further parallel processing applications (e.g., training of neural networks, etc.). Examples of GPU 842 perform calculations related to 3D computer graphics, include 2D acceleration and framebuffer capabilities, accelerate memory-intensive work of texture mapping and rendering polygons, accelerate geometric calculations such as the rotation and translation of vertices into different coordinate systems, support programmable shaders that manipulate vertices and textures, perform oversampling and interpolation techniques to reduce aliasing, and/or support very high-precision color spaces.

In examples, NPU 844 (also referred to as an “artificial intelligence (AI) accelerator” or “deep learning processor (DLP)”) is a processor or processing unit configured to accelerate artificial intelligence and machine learning applications, such as execution of machine learning (ML) model (MLM) 828. In an example, NPU 844 is configured for a data-driven parallel computing and is highly efficient at processing massive multimedia data such as videos and images and processing data for neural networks. NPU 844 is configured for efficient handling of AI-related tasks, such as speech recognition, background blurring in video calls, photo or video editing processes like object detection, etc.

In embodiments disclosed herein that implement ML models, NPU 844 can be utilized to execute such ML models, of which MLM 828 is an example. For instance, where applicable, MLM 828 is a generative AI model that generates content that is complex, coherent, and/or original. For instance, a generative AI model can create sophisticated sentences, lists, ranges, tables of data, images, essays, and/or the like. An example of a generative AI model is a language model. A language model is a model that estimates the probability of a token or sequence of tokens occurring in a longer sequence of tokens. In this context, a “token” is an atomic unit that the model is training on and making predictions on. Examples of a token include, but are not limited to, a word, a character (e.g., an alphanumeric character, a blank space, a symbol, etc.), a sub-word (e.g., a root word, a prefix, or a suffix). In other types of models (e.g., image based models) a token may represent another kind of atomic unit (e.g., a subset of an image). Examples of language models applicable to embodiments herein include large language models (LLMs), text-to-image Al image generation systems, text-to-video Al generation systems, etc. A large language model (LLM) is a language model that has a high number of model parameters. In examples, an LLM has millions, billions, trillions, or even greater numbers of model parameters. Model parameters of an LLM are the weights and biases the model learns during training. Some implementations of LLMs are transformer-based LLMs (e.g., the family of generative pre-trained transformer (GPT) models). A transformer is a neural network architecture that relies on self-attention mechanisms to transform a sequence of input embeddings into a sequence of output embeddings (e.g., without relying on convolutions or recurrent neural networks).

In further examples, NPU 844 is used to train MLM 828. To train MLM 828, training data is that includes input features (attributes) and their corresponding output labels/target values (e.g., for supervised learning) is collected. A training algorithm is a computational procedure that is used so that MLM 828 learns from the training data. Parameters/weights are internal settings of MLM 828 that are adjusted during training by the training algorithm to reduce a difference between predictions by MLM 828 and actual outcomes (e.g., output labels). In some examples, MLM 828 is set with initial values for the parameters/weights. A loss function measures a dissimilarity between predictions by MLM 828 and the target values, and the parameters/weights of MLM 828 are adjusted to minimize the loss function. The parameters/weights are iteratively adjusted by an optimization technique, such as gradient descent. In this manner, MLM 828 is generated through training by NPU 844 to be used to generate inferences based on received input feature sets for particular applications. MLM 828 is generated as a computer program or other type of algorithm configured to generate an output (e.g., a classification, a prediction/inference) based on received input features, and is stored in the form of a file or other data structure.

In examples, such training of MLM 828 by NPU 844 is supervised or unsupervised. According to supervised learning, input objects (e.g., a vector of predictor variables) and a desired output value (e.g., a human-labeled supervisory signal) train MLM 828. The training data is processed, building a function that maps new data on expected output values. Example algorithms usable by NPU 844 to perform supervised training of MLM 828 in particular implementations include support-vector machines, linear regression, logistic regression, Naïve Bayes, linear discriminant analysis, decision trees, K-nearest neighbor algorithm, neural networks, and similarity learning.

In an example of supervised learning where MLM 828 is an LLM, MLM 828 can be trained by exposing the LLM to (e.g., large amounts of) text (e.g., predetermined datasets, books, articles, text-based conversations, webpages, transcriptions, forum entries, and/or any other form of text and/or combinations thereof). In examples, training data is provided from a database, from the Internet, from a system, and/or the like. Furthermore, an LLM can be fine-tuned using Reinforcement Learning with Human Feedback (RLHF), where the LLM is provided the same input twice and provides two different outputs and a user ranks which output is preferred. In this context, the user's ranking is utilized to improve the model. Further still, in example embodiments, an LLM is trained to perform in various styles, e.g., as a completion model (a model that is provided a few words or tokens and generates words or tokens to follow the input), as a conversation model (a model that provides an answer or other type of response to a conversation-style prompt), as a combination of a completion and conversation model, or as another type of LLM model.

According to unsupervised learning, MLM 828 is trained to learn patterns from unlabeled data. For instance, in embodiments where MLM 828 implements unsupervised learning techniques, MLM 828 identifies one or more classifications or clusters to which an input belongs. During a training phase of MLM 828 according to unsupervised learning, MLM 828 tries to mimic the provided training data and uses the error in its mimicked output to correct itself (i.e., correct weights and biases). In further examples, NPU 844 perform unsupervised training of MLM 828 according to one or more alternative techniques, such as Hopfield learning rule, Boltzmann learning rule, Contrastive Divergence, Wake Sleep, Variational Inference, Maximum Likelihood, Maximum A Posteriori, Gibbs Sampling, and backpropagating reconstruction errors or hidden state reparameterizations.

Note that NPU 844 need not necessarily be present in all ML model embodiments. In embodiments where ML models are present, any one or more of processor 810, GPU 842, and/or NPU 844 can be present to train and/or execute MLM 828.

One or more wireless modems 860 can be coupled to antenna(s) (not shown) of computing device 802 and can support two-way communications between processor 810 and devices external to computing device 802 through network 804, as would be understood to persons skilled in the relevant art(s). Wireless modem 860 is shown generically and can include a cellular modem 866 for communicating with one or more cellular networks, such as a GSM network for data and voice communications within a single cellular network, between cellular networks, or between the mobile device and a public switched telephone network (PSTN). In examples, wireless modem 860 also or alternatively includes other radio-based modem types, such as a Bluetooth modem 864 (also referred to as a “Bluetooth device”) and/or Wi-Fi modem 862 (also referred to as an “wireless adaptor”). Wi-Fi modem 862 is configured to communicate with an access point or other remote Wi-Fi-capable device according to one or more of the wireless network protocols based on the IEEE (Institute of Electrical and Electronics Engineers) 802.11 family of standards, commonly used for local area networking of devices and Internet access. Bluetooth modem 864 is configured to communicate with another Bluetooth-capable device according to the Bluetooth short-range wireless technology standard(s) such as IEEE 802.15.1 and/or managed by the Bluetooth Special Interest Group (SIG).

Computing device 802 can further include power supply 882, LI receiver 884, accelerometer 886, and/or one or more wired interfaces 880. Example wired interfaces 880 include a USB port, IEEE 1394 (FireWire) port, a RS-232 port, an HDMI (High-Definition Multimedia Interface) port (e.g., for connection to an external display), a DisplayPort port (e.g., for connection to an external display), an audio port, and/or an Ethernet port, the purposes and functions of each of which are well known to persons skilled in the relevant art(s). Wired interface(s) 880 of computing device 802 provide for wired connections between computing device 802 and network 804, or between computing device 802 and one or more devices/peripherals when such devices/peripherals are external to computing device 802 (e.g., a pointing device, display 854, speaker 852, camera 836, physical keyboard 838, etc.). Power supply 882 is configured to supply power to each of the components of computing device 802 and receives power from a battery internal to computing device 802, and/or from a power cord plugged into a power port of computing device 802 (e.g., a USB port, an A/C power port). LI receiver 884 is useable for location determination of computing device 802 and in examples includes a satellite navigation receiver such as a Global Positioning System (GPS) receiver and/or includes other type of location determiner configured to determine location of computing device 802 based on received information (e.g., using cell tower triangulation, etc.). Accelerometer 886, when present, is configured to determine an orientation of computing device 802.

Note that the illustrated components of computing device 802 are not required or all-inclusive, and fewer or greater numbers of components can be present as would be recognized by one skilled in the art. In examples, computing device 802 includes one or more of a gyroscope, barometer, proximity sensor, ambient light sensor, digital compass, etc. In an example, processor 810 and memory 856 are co-located in a same semiconductor device package, such as being included together in an integrated circuit chip, FPGA, or system-on-chip (SOC), optionally along with further components of computing device 802.

In embodiments, computing device 802 is configured to implement any of the above-described features of flowcharts herein. Computer program logic for performing any of the operations, steps, and/or functions described herein is stored in storage 820 and executed by processor 810.

In some embodiments, server infrastructure 870 is present in computing environment 800 and is communicatively coupled with computing device 802 via network 804. Server infrastructure 870, when present, is a network-accessible server set (e.g., a cloud-based environment or platform). As shown in FIG. 8, server infrastructure 870 includes clusters 872. Each of clusters 872 comprises a group of one or more compute nodes and/or a group of one or more storage nodes. For example, as shown in FIG. 8, cluster 872 includes nodes 874. Each of nodes 874 are accessible via network 804 (e.g., in a “cloud-based” embodiment) to build, deploy, and manage applications and services. In examples, any of nodes 874 is a storage node that comprises a plurality of physical storage disks, SSDs, and/or other physical storage devices that are accessible via network 804 and are configured to store data associated with the applications and services managed by nodes 874.

Each of nodes 874, as a compute node, comprises one or more server computers, server systems, and/or computing devices. For instance, a node 874 in accordance with an embodiment includes one or more of the components of computing device 802 disclosed herein. Each of nodes 874 is configured to execute one or more software applications (or “applications”) and/or services and/or manage hardware resources (e.g., processors, memory, etc.), which are utilized by users (e.g., customers) of the network-accessible server set. In examples, as shown in FIG. 8, nodes 874 includes a node 846 that includes storage 848 and/or one or more of a processor 858 (e.g., similar to processor 810, GPU 842, and/or NPU 844 of computing device 802). Storage 848 stores application programs 876 and application data 878. Processor(s) 858 operate application programs 876 which access and/or generate related application data 878. In an implementation, nodes such as node 846 of nodes 874 operate or comprise one or more virtual machines, with each virtual machine emulating a system architecture (e.g., an operating system), in an isolated manner, upon which applications such as application programs 876 are executed.

In embodiments, one or more of clusters 872 are located/co-located (e.g., housed in one or more nearby buildings with associated components such as backup power supplies, redundant data communications, environmental controls, etc.) to form a datacenter, or are arranged in other manners. Accordingly, in an embodiment, one or more of clusters 872 are included in a datacenter in a distributed collection of datacenters. In embodiments, exemplary computing environment 800 comprises part of a cloud-based platform.

In an embodiment, computing device 802 accesses application programs 876 for execution in any manner, such as by a client application and/or a browser at computing device 802.

In an example, for purposes of network (e.g., cloud) backup and data security, computing device 802 additionally and/or alternatively synchronizes copies of application programs 814 and/or application data 816 to be stored at network-based server infrastructure 870 as application programs 876 and/or application data 878. In examples, operating system 812 and/or application programs 814 include a file hosting service client configured to synchronize applications and/or data stored in storage 820 at network-based server infrastructure 870.

In some embodiments, on-premises servers 892 are present in computing environment 800 and are communicatively coupled with computing device 802 via network 804. On-premises servers 892, when present, are hosted within an organization's infrastructure and, in many cases, physically onsite of a facility of that organization. On- premises servers 892 are controlled, administered, and maintained by IT (Information Technology) personnel of the organization or an IT partner to the organization. Application data 898 can be shared by on-premises servers 892 between computing devices of the organization, including computing device 802 (when part of an organization) through a local network of the organization, and/or through further networks accessible to the organization (including the Internet). Furthermore, in examples, on-premises servers 892 serve applications such as application programs 896 to the computing devices of the organization, including computing device 802. Accordingly, in examples, on-premises servers 892 include storage 894 (which includes one or more physical storage devices such as storage disks and/or SSDs) for storage of application programs 896 and application data 898 and include a processor 890 (e.g., similar to processor 810, GPU 842, and/or NPU 844 of computing device 802) for execution of application programs 896. In some embodiments, multiple processors 890 are present for execution of application programs 896 and/or for other purposes. In further examples, computing device 802 is configured to synchronize copies of application programs 814 and/or application data 816 for backup storage at on-premises servers 892 as application programs 896 and/or application data 898.

Embodiments described herein may be implemented in one or more of computing device 802, network-based server infrastructure 870, and on-premises servers 892. For example, in some embodiments, computing device 802 is used to implement systems, clients, or devices, or components/subcomponents thereof, disclosed elsewhere herein. In other embodiments, a combination of computing device 802, network-based server infrastructure 870, and/or on-premises servers 892 is used to implement the systems, clients, or devices, or components/subcomponents thereof, disclosed elsewhere herein.

As used herein, the terms “computer program medium,” “computer-readable medium,” “computer-readable storage medium,” and “computer-readable storage device,” etc., are used to refer to physical hardware media. Examples of such physical hardware media include any hard disk, optical disk, SSD, other physical hardware media such as RAMs, ROMs, flash memory, digital video disks, zip disks, MEMs (microelectronic machine) memory, nanotechnology-based storage devices, and further types of physical/tangible hardware storage media of storage 820. Such computer-readable media and/or storage media are distinguished from and non-overlapping with communication media, propagating signals, and signals per se. Stated differently, “computer program medium,” “computer-readable medium,” “computer-readable storage medium,” and “computer-readable storage device” do not encompass communication media, propagating signals, and signals per se. Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared, and other wireless media, as well as wired media. Embodiments are also directed to such communication media that are separate and non-overlapping with embodiments directed to computer-readable storage media.

As noted above, computer programs and modules (including application programs 814) are stored in storage 820. Such computer programs can also be received via wired interface(s) 860 and/or wireless modem(s) 860 over network 804. Such computer programs, when executed or loaded by an application, enable computing device 802 to implement features of embodiments discussed herein. Accordingly, such computer programs represent controllers of the computing device 802.

Embodiments are also directed to computer program products comprising computer code or instructions stored on any computer-readable medium or computer-readable storage medium. Such computer program products include the physical storage of storage 820 as well as further physical storage types.

### IV. Additional Example Embodiments

A system for mitigating a security risk is disclosed herein. The system includes: a processor; and a memory device that stores program code structured to cause the processor to: obtain a resource ownership mapping that maps a resource name to a history of ownerships of the resource name and an action associated with the resource name, the history of ownerships including a first owner; determine, from the resource ownership mapping, a first ownership change of the resource name relating to the first owner; identify a reference to the resource name in a first computing environment associated with the first owner; and perform a preventative action to reduce a risk of a security event occurring in the first computing environment.

In one implementation of the foregoing system, the program code is structured to cause the processor to perform the preventative action by at least one of: generating a notification to the first owner, or preventing the first computing environment from accessing a resource with the resource name.

In another implementation of the foregoing system, the program code is further structured to cause the processor to: identify a resource name operation from a network resource, the resource name operation comprising the resource name, the action, and an indication that the action was performed by the first owner; and store the resource name, the action, and an indication that action was performed by the first owner in the resource ownership mapping.

In another implementation of the foregoing system, the action comprises one of: a creation of the resource name, a deletion of the resource name, or a name change of the resource name.

In another implementation of the foregoing system, the resource ownership mapping comprises a timestamp associated with the action.

In another implementation of the foregoing system, the resource name corresponds to a resource that comprises one of: a cloud storage, an account, a registry service, or an application service.

In another implementation of the foregoing system, the program code is further structured to cause the processor to: determine, from the resource ownership mapping, a second ownership change of the resource name relating to a second owner, the second ownership change indicating that the second owner is a subsequent owner of the resource name; and in response to the determination of the second ownership change, perform the preventative action.

In another implementation of the foregoing system, the program code is structured to cause the processor to perform the preventative action by: generating a notification to the first owner, the notification indicating that the resource name is owned by another entity.

In another implementation of the foregoing system, the program code is further structured to cause the processor to: determine that the reference to the resource name in the first computing environment comprises a first identification of a first sub-resource accessed via the resource name; determine that a second computing environment associated with the second owner comprises a second identification of a second sub-resource accessed via the resource name, the second identification matching the first identification; and in response to the determination that the second computing environment comprises the second identification of the second sub-resource, perform the preventative action.

In another implementation of the foregoing system, the first owner and the second owner are different tenants of a cloud provider, and the resource name corresponds to a cloud resource of the cloud provider.

A method for mitigating a security risk is disclosed herein. The method includes: obtaining a resource ownership mapping that maps a resource name to a history of ownerships of the resource name and an action associated with the resource name, the history of ownerships including a first owner; determining, from the resource ownership mapping, a first ownership change of the resource name relating to the first owner; identifying a reference to the resource name in a first computing environment associated with the first owner; and performing a preventative action to reduce a risk of a security event occurring in the first computing environment.

In one implementation of the foregoing method, the performing the preventative action comprises at least one of: generating a notification to the first owner, or preventing the first computing environment from accessing a resource with the resource name.

In another implementation of the foregoing method, the method further comprises: identifying a resource name operation from a network resource, the resource name operation comprising the resource name, the action, and an indication that the action was performed by the first owner; and storing the resource name, the action, and an indication that action was performed by the first owner in the resource ownership mapping.

In another implementation of the foregoing method, the action comprises one of: a creation of the resource name, a deletion of the resource name, or a name change of the resource name.

In another implementation of the foregoing method, the method further comprises: determining, from the resource ownership mapping, a second ownership change of the resource name relating to a second owner, the second ownership change indicating that the second owner is a subsequent owner of the resource name; and in response to the determining the second ownership change, performing the preventative action.

In another implementation of the foregoing method, the method further comprises: determining that the reference to the resource name in the first computing environment comprises a first identification of a first sub-resource accessed via the resource name; determining that a second computing environment associated with the second owner comprises a second identification of a second sub-resource accessed via the resource name, the second identification matching the first identification; and in response to the determining that the second computing environment comprises the second identification of the second sub-resource, performing the preventative action.

A computer-readable storage medium is disclosed herein. The computer-readable storage medium has computer program code recorded thereon that when executed by at least one processor causes the at least one processor to perform a method comprising: obtaining a resource ownership mapping that maps a resource name to a history of ownerships of the resource name and an action associated with the resource name, the history of ownerships including a first owner; determining, from the resource ownership mapping, a first ownership change of the resource name relating to the first owner; identifying a reference to the resource name in a first computing environment associated with the first owner; and performing a preventative action to reduce a risk of a security event occurring in the first computing environment.

In one implementation of the foregoing computer-readable storage medium, the performing the preventative action comprises at least one of: generating a notification to the first owner, or preventing the first computing environment from accessing a resource with the resource name.

In another implementation of the foregoing computer-readable storage medium, the method further comprises: determining, from the resource ownership mapping, a second ownership change of the resource name relating to a second owner, the second ownership change indicating that the second owner is a subsequent owner of the resource name; and in response to the determining the second ownership change, performing the preventative action.

In another implementation of the foregoing computer-readable storage medium, the method further comprises: determining that the reference to the resource name in the first computing environment comprises a first identification of a first sub-resource accessed via the resource name; determining that a second computing environment associated with the second owner comprises a second identification of a second sub-resource accessed via the resource name, the second identification matching the first identification; and in response to the determining that the second computing environment comprises the second identification of the second sub-resource, performing the preventative action.

### V. Conclusion

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

In the discussion, unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of the embodiment for an application for which it is intended. Furthermore, where “based on” is used to indicate an effect being a result of an indicated cause, it is to be understood that the effect is not required to only result from the indicated cause, but that any number of possible additional causes may also contribute to the effect. Thus, as used herein, the term “based on” should be understood to be equivalent to the term “based at least on.”

While various embodiments of the present disclosure have been described above, it should be understood that they have been presented by way of example only, and not limitation. It will be understood by those skilled in the relevant art(s) that various changes in form and details may be made therein without departing from the spirit and scope of the embodiments as defined in the appended claims. Accordingly, the breadth and scope of the claimed embodiments should not be limited by any of the above-described exemplary embodiments, but should be defined only in accordance with the following claims and their equivalents.

What is claimed is:

1. A system for mitigating a security risk, the system comprising:
a processor; and
a memory device that stores program code structured to cause the processor to:
obtain a resource ownership mapping that maps a resource name to a history of ownerships of the resource name and an action associated with the resource name, the history of ownerships including a first owner;
determine, from the resource ownership mapping, a first ownership change of the resource name relating to the first owner;
identify a reference to the resource name in a first computing environment associated with the first owner; and
perform a preventative action to reduce a risk of a security event occurring in the first computing environment.

2. The system of claim 1, wherein the program code is structured to cause the processor to perform the preventative action by at least one of:
generating a notification to the first owner, or
preventing the first computing environment from accessing a resource with the resource name.

3. The system of claim 1, wherein the program code is further structured to cause the processor to:
identify a resource name operation from a network resource, the resource name operation comprising the resource name, the action, and an indication that the action was performed by the first owner; and
store the resource name, the action, and an indication that action was performed by the first owner in the resource ownership mapping.

4. The system of claim 1, wherein the action comprises one of:
a creation of the resource name,
a deletion of the resource name, or
a name change of the resource name.

5. The system of claim 1, wherein the resource ownership mapping comprises a timestamp associated with the action.

6. The system of claim 1, wherein the resource name corresponds to a resource that comprises one of:
a cloud storage,
an account,
a registry service, or
an application service.

7. The system of claim 1, wherein the program code is further structured to cause the processor to:
determine, from the resource ownership mapping, a second ownership change of the resource name relating to a second owner, the second ownership change indicating that the second owner is a subsequent owner of the resource name; and
in response to the determination of the second ownership change, perform the preventative action.

8. The system of claim 7, wherein the program code is structured to cause the processor to perform the preventative action by:
generating a notification to the first owner, the notification indicating that the resource name is owned by another entity.

9. The system of claim 7, wherein the program code is further structured to cause the processor to:
determine that the reference to the resource name in the first computing environment comprises a first identification of a first sub-resource accessed via the resource name;
determine that a second computing environment associated with the second owner comprises a second identification of a second sub-resource accessed via the resource name, the second identification matching the first identification; and
in response to the determination that the second computing environment comprises the second identification of the second sub-resource, perform the preventative action.

10. The system of claim 7, wherein the first owner and the second owner are different tenants of a cloud provider, and the resource name corresponds to a cloud resource of the cloud provider.

11. A method for mitigating a security risk, the method comprising:
obtaining a resource ownership mapping that maps a resource name to a history of ownerships of the resource name and an action associated with the resource name, the history of ownerships including a first owner;
determining, from the resource ownership mapping, a first ownership change of the resource name relating to the first owner;
identifying a reference to the resource name in a first computing environment associated with the first owner; and
performing a preventative action to reduce a risk of a security event occurring in the first computing environment.

12. The method of claim 11, wherein the performing the preventative action comprises at least one of:
generating a notification to the first owner, or
preventing the first computing environment from accessing a resource with the resource name.

13. The method of claim 11, further comprising:
identifying a resource name operation from a network resource, the resource name operation comprising the resource name, the action, and an indication that the action was performed by the first owner; and
storing the resource name, the action, and an indication that action was performed by the first owner in the resource ownership mapping.

14. The method of claim 11, wherein the action comprises one of:
a creation of the resource name,
a deletion of the resource name, or
a name change of the resource name.

15. The method of claim 11, further comprising:
determining, from the resource ownership mapping, a second ownership change of the resource name relating to a second owner, the second ownership change indicating that the second owner is a subsequent owner of the resource name; and
in response to the determining the second ownership change, performing the preventative action.

16. The method of claim 15, further comprising:
determining that the reference to the resource name in the first computing environment comprises a first identification of a first sub-resource accessed via the resource name;
determining that a second computing environment associated with the second owner comprises a second identification of a second sub-resource accessed via the resource name, the second identification matching the first identification; and
in response to the determining that the second computing environment comprises the second identification of the second sub-resource, performing the preventative action.

17. A computer-readable storage medium having computer program code recorded thereon that when executed by at least one processor causes the at least one processor to perform a method comprising:
obtaining a resource ownership mapping that maps a resource name to a history of ownerships of the resource name and an action associated with the resource name, the history of ownerships including a first owner;
determining, from the resource ownership mapping, a first ownership change of the resource name relating to the first owner;
identifying a reference to the resource name in a first computing environment associated with the first owner; and
performing a preventative action to reduce a risk of a security event occurring in the first computing environment.

18. The computer-readable storage medium of claim 17, wherein the performing the preventative action comprises at least one of:
generating a notification to the first owner, or
preventing the first computing environment from accessing a resource with the resource name.

19. The computer-readable storage medium of claim 17, wherein the method further comprises:
determining, from the resource ownership mapping, a second ownership change of the resource name relating to a second owner, the second ownership change indicating that the second owner is a subsequent owner of the resource name; and
in response to the determining the second ownership change, performing the preventative action.

20. The computer-readable storage medium of claim 19, wherein the method further comprises:
determining that the reference to the resource name in the first computing environment comprises a first identification of a first sub-resource accessed via the resource name;
determining that a second computing environment associated with the second owner comprises a second identification of a second sub-resource accessed via the resource name, the second identification matching the first identification; and
in response to the determining that the second computing environment comprises the second identification of the second sub-resource, performing the preventative action.
